(19) United States
(12) Patent Application Publication
(10) Pub. No.: US 2025/0175568 A1
(43) Pub. Date: May 29, 2025

(54) IMAGE READING DEVICE, DOCUMENT AREA DISCRIMINATION METHOD IN IMAGE READING DEVICE AND PROGRAM

(71) Applicant: SEIKO EPSON CORPORATION, Tokyo (JP)

(72) Inventor: Hikari ISHIHARA, KITAKYUSHU-SHI (JP)

(21) Appl. No.: 18/958,163

(22) Filed: Nov. 25, 2024

(30) Foreign Application Priority Data
Nov. 28, 2023 (JP) 2023-200569

(51) Int. Cl. H04N 1/04; G06T 7/13; G06T 7/194; G06V 20/80; G06V 30/40

(52) U.S. Cl. CPC H04N 1/04; G06T 7/13; G06T 7/194; G06V 20/80; G06V 30/40

(57) ABSTRACT

The image reading device includes a reading section configured to read an image of a document and a background forming section that causes the reading section to read a background including a pattern with a specific cycle. A control section sets three or more continuous M-number of pixels in a direction with a cycle of the pattern in image data, determines the presence or absence of a short cycle fluctuation, which is a cyclical fluctuation of the brightness value specific to the pattern, for each of the single unit based on the brightness values of the M-number of pixels for each of the single unit, and discriminates between the document area and the background area based on the position at which the presence or absence of the short cycle fluctuation obtained from the image data switches.

The present application is based on, and claims priority from JP Application Serial Number 2023-200569, filed Nov. 28, 2023, the disclosure of which is hereby incorporated by reference herein in its entirety.

### BACKGROUND

### 1. Technical Field

The present disclosure relates to an image reading device including a reading section that reads a document, a document area discrimination method in the image reading device, and a program.

### 2. Related Art

For example, JP-A-2023-124289 discloses an image reading device including a reading section for reading a document. The image reading device includes a background plate on which black and white stripes (an example of a stripe pattern) are drawn at a position facing the reading section. In an image obtained by reading a document, the black and white stripes are read as the background of the document. A document area is obtained from the positions of the vertices of black stripes formed by black stripes among the black and white stripes and the boundary of the document.

However, since the image reading device described in JP-A-2023-124289 adopts a method of detecting the position of the vertices of black stripes, it is necessary to increase the number of vertices detected by making the stripes finer in order to increase the detection accuracy of the document area. However, if the stripes are made finer, it becomes difficult to specify the vertices, and a detection error is likely to occur. For this reason, there is a demand for improvement in accuracy of acquiring a document area using a pattern with a specific cycle such as a stripe pattern.

### SUMMARY

In order to solve the above problem, an image reading device includes a reading section configured to read an image of a document, a background forming section for causing the reading section to read a background including a pattern with a specific cycle, and a control section, wherein in the image data obtained by the reading section reading the document, three or more M-number of pixels continuous in a direction with the cycle of the pattern are considered as a single unit, and the control section determines, for each of the single units, the presence or absence of a short cycle fluctuation, which is a cyclical fluctuation in brightness value specific to the pattern, based on brightness values of the M-number of pixels for each of the single units, and discriminates between a document area and a background area based on a position where the presence or absence of the short cycle fluctuation of a plurality of units obtained from the image data switches.

A document area discrimination method in an image reading device that solves the above problem is a document area discrimination method in the image reading device for discriminating between a document area and a background area in the image data read by a reading section configured to read an image of a document, the method including acquiring image data of the document having a pattern with a specific cycle as a background by causing the document to be read by the reading section, and determining presence or absence of a short cycle fluctuation, which is a cyclical fluctuation in brightness value specific to the pattern, for each single unit and based on brightness value of M-number of pixels in each single unit, wherein three or more M-number of pixels continuous in a direction with the cycle of the pattern in the image data are considered as a single unit, and discriminating between the document area and the background area based on a position where the presence or absence of the short cycle fluctuation of a plurality of units obtained from the image data switches.

A program for solving the above problem is a program that causes a computer of an image reading device, which includes a reading section configured to retrieve an image of a document, to determine a document area and a background area in image data read by the reading section, wherein the program causing the computer to cause the reading section to read the document and retrieve, from a memory section, image data of the document having a pattern with a specific cycle as a background, perform a determination process of determining presence or absence of a short cycle fluctuation, which is a cyclical fluctuation in brightness value specific to the pattern, for each single unit and based on brightness value of M-number of pixels in each single unit, wherein three or more M-number of pixels continuous in a direction with the cycle of the pattern in the image data are considered as a single unit, and perform a discrimination process of discriminating the document area and the background area based on a position where the presence or absence of the short cycle fluctuation of a plurality of units obtained from the image data switches.

### BRIEF DESCRIPTION OF THE DRAWINGS

FIG. 1 is a perspective view showing an image reading device according to the first embodiment.

FIG. 2 is a schematic side sectional view showing an image reading device.

FIG. 3 is a schematic perspective view showing a configuration of a portion where the reading section reads a document.

FIG. 4 is a schematic plan view showing an image sensor.

FIG. 5 is a schematic plan view showing a background plate.

FIG. 6 is a block diagram showing an electrical configuration of an image reading system.

FIG. 7 is a schematic diagram illustrating image data obtained by the image sensor reading a document.

FIG. 8 is a graph showing a relationship between pixel positions and brightness values of image data obtained by reading a document.

FIG. 9 is an enlarged view showing a background area in the high-resolution image data.

FIG. 10 is a graph for explaining a calculation equation for obtaining a calculated value used for detection (determination) of a document area.

FIG. 11 is an enlarged view showing a background area in the low-resolution image data.

FIG. 12 is a graph for explaining a calculation equation for obtaining a calculated value used for detection (determination) of a document area.

FIG. 13 is a schematic diagram showing the judgment image data in which the calculated value is the brightness value.

FIG. 14 is a diagram showing actual image data obtained by reading a document.

FIG. 15 is a diagram showing a binarized image obtained by binarizing the judgment image data.

FIG. 16 is a graph showing brightness fluctuation in the main scanning direction.

FIG. 17 is a graph showing the brightness fluctuation in the main scanning direction as a moving average value of N pixels.

FIG. 18 is a flowchart showing a document area detection processing routine.

FIG. 19 is a flowchart showing the glass stain detection processing routine.

FIG. 20A is an enlarged view showing a background area in high-resolution image data according to the second embodiment.

FIG. 20B is an enlarged view showing a background area in high-resolution image data.

FIG. 20C is an enlarged view showing a background area in high-resolution image data.

FIG. 21A is an enlarged view showing a background area in the low-resolution image data.

FIG. 21B is an enlarged view showing a background area in the low-resolution image data.

FIG. 21C is an enlarged view showing a background area in the low-resolution image data.

FIG. 22 is a schematic perspective view showing a stripe pattern forming section in a modification example.

FIG. 23 is a schematic diagram showing an image of a background area having a stripe pattern as a background.

FIG. 24 is a schematic perspective view showing a stripe pattern forming section in a modification example different from FIG. 22.

FIG. 25 is a schematic diagram showing an image of a background area having an inclined stripe pattern as a background.

FIG. 26 is a schematic diagram showing an image of a background area having a grid pattern as a background.

FIG. 27 is a graph for explaining pixels used for calculation in the low-resolution mode.

FIG. 28 is a schematic plan view showing a background plate of a modification example.

### DESCRIPTION OF EMBODIMENTS

### First Embodiment

Hereinafter, a first embodiment of the image reading device will be described with reference to the drawings.

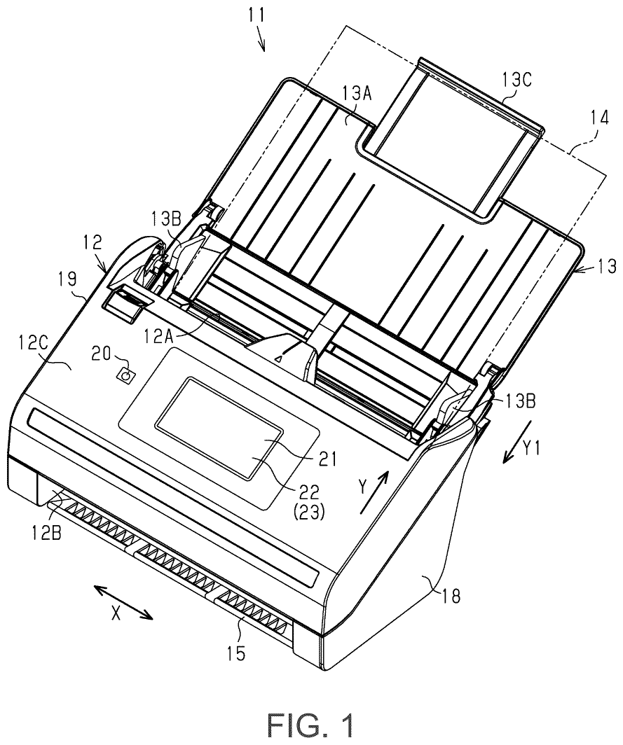

As shown in FIG. 1, an image reading device 11 of the present embodiment includes a main body 12 having a substantially trapezoidal shape in a side view, and a document support 13 on which a document 14 as an image reading target is placed (set). In the main body 12, a stacker 15 is accommodated on the lower side of the discharge port 12B in a state of being slidable in the front-rear direction.

The document support 13 has a flat placement surface 13A on which plural sheets of the document 14 can be placed by extending inclined upward from the rear side of the main body 12. The document support 13 is provided with a pair of edge guides 13B that are slidable in a widthwise direction X intersecting (in particular, orthogonal to) the transport direction Y1 in which the document 14 is transported. The document 14 stacked on the placement surface 13A is positioned in the width direction X with respect to the feed port 12A by being sandwiched by the pair of edge guides 13B. A slide type auxiliary support section 13C is provided on the placement surface 13A of the document support 13 so as to be retractable. The document 14 stacked on the placement surface 13A is positioned in the transport direction Y1 with respect to the feed port 12A by abutting against the slide type auxiliary support section 13C. The width direction X is the main scanning direction when the image reading device 11 reads the document 14, and the direction opposite to the transport direction Y1 is the sub-scanning direction Y. Hereinafter, it is also referred to as the main scanning direction X.

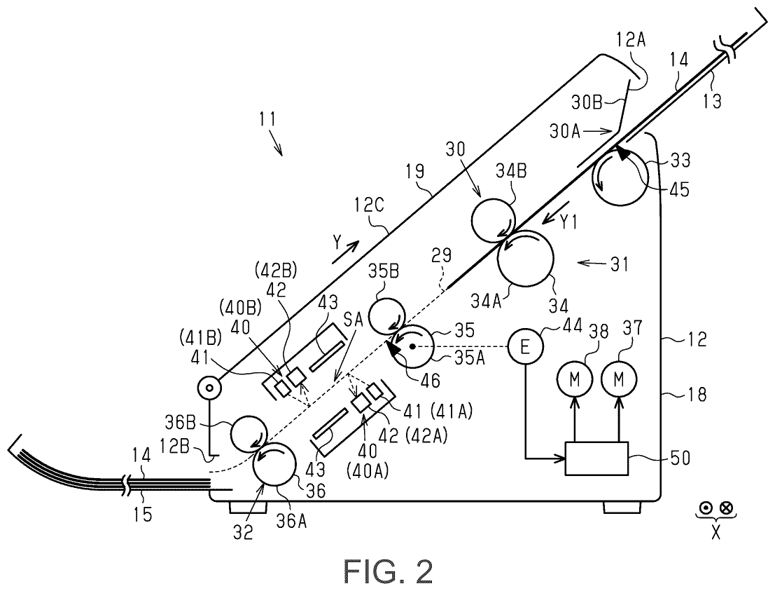

The document 14 placed on the document support 13 is fed one sheet at a time into the main body 12 from a feed port 12A opened in an upper portion of the main body 12. The fed document 14 is transported along a predetermined transport path 29 (refer to FIG. 2) in the main body 12, and after an image is read in a reading area SA during transport, the document 14 is discharged from a discharge port 12B, which is opened in a front lower portion of the main body 12.

A power button 20 is provided on the front section 12C of the main body 12. In the front section 12C of the main body 12, a display section 22 such as a liquid crystal panel for displaying a predetermined image in the display area 23 is provided. The display section 22 displays information such as menus, selection items, and the operation status of the image reading device 11. The display section 22 is provided with an operation section 21, such as a touch panel, which is capable of detecting the touch operation of the user. The operation section 21 is configured to input necessary information according to a user's touch operation when giving an instruction to the image reading device 11.

As shown in FIG. 2, the main body 12 includes a main body section 18 and a cover section 19 connected to the main body section 18 so as to be pivotable about a front end portion of the main body section 18. The main body 12 includes a transport path 29 (transport passage) extending from the feed port 12A to the discharge port 12B between the main body section 18 and the cover section 19.

A transport mechanism 30 for transporting the document 14 is provided in the main body 12. The transport mechanism 30 includes a feed section 30A that feeds the document 14 stacked (set) on the document support 13 while guiding the document 14 into the main body 12 one sheet at a time, a transport section 31 that transports the fed document 14 so as to pass through the reading area SA along the transport path 29, and a discharge section 32 that discharges the document 14 after the image is read during transport by the transport section 31. The transport mechanism 30 has an automatic document feeding function for sequentially transporting the document 14 stacked on the document support 13 one sheet at a time along the transport path 29 so as to pass through the reading area SA.

The feed section 30A includes one feed roller 33 (pickup roller) which faces the feed guide 30B at an upstream end position of the transport path 29 in the main body 12. The feed section 30A feeds plural sheets of the document 14 stacked on the document support 13 one sheet at a time from the feed port 12A along the feed guide 30B.

The transport section 31 includes a feed roller pair 34 disposed at a position downstream of the feed roller 33 in the transport direction Y1, and a transport roller pair 35 disposed at a position upstream of the reading area SA in the transport direction Y1. The feed roller pair 34 includes a drive roller 34A and a separation roller 34B (retard roller). The pair of transport rollers 35 includes a drive roller 35A and a driven roller 35B.

The discharge section 32 includes a discharge roller pair 36 disposed at a position downstream of the reading area SA in the transport direction Y1. The discharge roller pair 36 includes a drive roller 36A and a driven roller 36B. The discharge roller pair 36, together with the transport roller pair 35, also serves to transport the document 14 during reading.

As described above, from the upstream side in the transport direction Y1, the feed roller 33, the feed roller pair 34, the transport roller pair 35, and the discharge roller pair 36 are arranged in this order, and each pair is arranged at intervals in the widthwise direction X.

The plurality of rollers 33 and 34A of the feeding system are rotationally driven by the power of a feed motor 37, which is a power source thereof. The plural sheets of document 14 stacked on the document support 13 are sequentially fed into the main body 12 from the feed port 12A one by one from the lowermost sheet by the feed roller 33. In this way, the feed section 30A (rollers 33, 34A, and the like) is driven by the feed motor 37 as a power source.

Further, the separation roller 34B of the feeding system and the drive rollers 35A and 36A of the transporting system are rotationally driven by the power of a transport motor 38, which is the power source thereof. The document 14 fed into the main body 12 by the feed roller 33 is discharged from the discharge port 12B after being transported to the reading area SA. In this way, the transport section 31 (the transport roller pair 34 and the like) and the discharge section 32 (the discharge roller pair 36 and the like) are driven by the transport motor 38 as a common power source.

Further, the drive rollers 35A and 36A are rotationally driven so as to transport the document 14 at the same transport speed (reading speed) when reading the document 14. Each of the driven rollers 35B and 36B rotates together by rotation of the pair of drive rollers 35A and 36A.

In addition, an encoder 44 (for example, a rotary encoder), which can detect the rotation of one drive roller of the feeding system among the plurality of roller pairs 34 to 36, is provided in the main body 12. The encoder 44 outputs a detection signal including the number of pulses proportional to the rotation amount of the drive roller to the control section 50 (controller). Therefore, the control section 50 can grasp the position (transport position) of the document 14 being transported and grasp the transport speed based on the detection signal of the encoder 44.

The document sensor 45 that detects the presence or absence of the document 14 set on the document support 13 is disposed between the pair of feed rollers 33. The document presence sensor 46, which is capable of detecting the presence or absence of the document 14, is disposed at a position slightly downstream of the nip point of the transport roller pair 35 in the transport direction Y1. Based on the detection signal (ON/OFF) of the document presence sensor 46, the control section 50 detects that the leading end of the document 14 has passed through the transport roller pair 35 and that the trailing end of the document 14 has passed through the transport roller pair 35. The detection result obtained when the document presence sensor 46 detects the leading end and the trailing end of the document 14 is used for control to determine the timing of the start and end of the reading operation of the reading section 40 (40A, 40B), which will be described later.

The image reading device 11 includes a reading section 40 for reading the document 14 in the main body 12. A pair of reading sections 40 is provided on both sides of the transport path 29 at a position between the transport roller pair 35 and the discharge roller pair 36 in the transport direction Y1. In the present embodiment, the pair of reading sections 40 includes a first reading section 40A that reads the front side (lower side) of the document 14 transported along the transport path 29 and a second reading section 40B that reads the back side (upper side) of the document 14 transported along the transport path 29. The pair of reading sections 40 are disposed at positions slightly shifted from each other in the transport direction Y1, but a configuration in which one of the reading sections is not provided may be adopted.

The reading section 40 includes a light source 41 that can irradiate the document 14 being transported with light by irradiating the reading area SA with light, and an image sensor 42 that can read an image from the document 14. In the normal reading mode, only the first reading section 40A performs a reading operation to read the front surface of the document 14, and in the double-sided reading mode, both the first reading section 40A and the second reading section 40B perform a reading operation to read both sides (front and back surfaces) of the document 14.

The light source 41 is composed of, for example, an LED or a fluorescent lamp. The image sensor 42 receives light emitted from the light source 41 and reflected by the document 14, converts the received light into an electric signal, and outputs a pixel signal having a value corresponding to the amount of received light. As described above, the image sensor 42 is a sensor for reading an image. The image sensor 42 is, for example, a linear image sensor. The image reading device 11 can perform color scanning and monochrome scanning (gray scale scanning). In the following, the light source 41 and the image sensor 42 on the side of the first reading section 40A are referred to as the first light source 41A and the first image sensor 42A, respectively, while those on the side of the second reading section 40B may be referred to as the second light source 41B and the second image sensor 42B, respectively.

The image sensor 42 is, for example, a contact type image sensor in which a plurality of photoelectric conversion elements are arranged in a line along the main scanning direction X. Furthermore, the image sensor 42 is specifically a complementary metal oxide semiconductor (CMOS) image sensor. The image sensor 42 photoelectrically converts light received by each photoelectric conversion element and outputs a pixel signal having a value corresponding to the amount of received light.

For example, in the case of double-sided reading, both sides of the document 14 are read by the first image sensor 42A and the second image sensor 42B. In the case of single-sided reading, the front side of the document 14 is read by the first image sensor 42A. The image sensor 42A and 42B has a reading area wider than the maximum document size readable by the image reading device 11.

Further, a background plate 43 as an example of a background forming section 60 is disposed at a position facing the image sensor 42 with the transport path 29 interposed therebetween. The background plate 43 is disposed over a region wider than the transport region of the document 14 in the main scanning direction X in the reading target range of the reading section 40. That is, the background plate 43 is disposed over a slightly wider range in the main scanning direction X than the width of the document 14 of the maximum size. The background plate 43 is disposed in a range including at least a region facing the reading ranges of the image sensor 42A and image sensor 42B in the main scanning direction X. The image sensor 42A and 42B read the background plate 43 in a region where the document 14 does not exist. Therefore, the background plate 43 is read as the background of the document 14. That is, the background plate 43 has a function of forming a background of the document in the read image in which the document 14 is read.

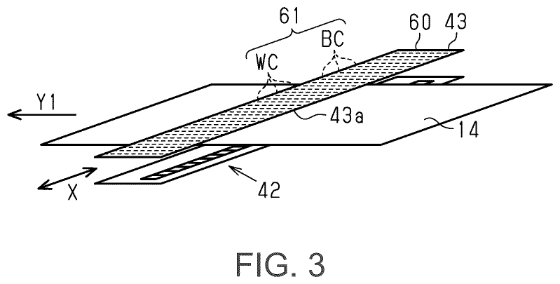

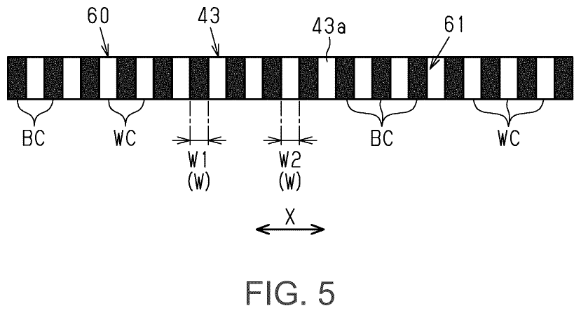

Here, the background plate 43 will be described with reference to FIGS. 3 and 5. As shown in FIG. 3, the background plate 43 is disposed at a position facing the image sensor 42 across the transport path of the document 14. A stripe pattern 61 as shown in FIG. 5 is drawn on a read surface 43a of the background plate 43. The read surface 43a faces the image sensor 42.

As shown in FIG. 5, the stripe pattern 61 is, for example, a black and white stripe pattern. The stripe pattern 61 is a black and white stripe pattern in which black lines BC and white lines WC, which are lines that configure the stripe pattern and that extend in the sub-scanning direction Y, are alternately arranged. The black lines BC and the white lines WC are alternately arranged in the main scanning direction X. The black lines BC and the white lines WC have the same thickness. Thus, the stripe pattern 61, which causes the background forming section 60 to be read by the reading section 40, includes black and white. The stripe pattern 61 is not limited to the two-color stripe pattern of black lines and white lines. For example, it may be a two-color stripe pattern of a dark color and a light color.

For example, the density value is set to 100% from the lowest gradation value to the highest gradation value. In this case, the stripe pattern may be a two-color stripe pattern of a first color indicated by a gradation value of 20% or less and a second color indicated by a gradation value of 80% or more. For example, in the case of one gradation, black is the gradation value “0” (0%), and white is the gradation value “256” (100%). The combination of the two colors may be, for example, 60% or more when the difference between the gradation values of the two colors is represented by %. The greater the difference between the tone values, the higher the detection accuracy for detecting the edge of the document 14I in the image data SD. In this respect, it is preferable that the difference between the gradation values of the two colors is 80% or more rather than 60% or more. For example, the stripe pattern may be formed by a combination of a first color indicated by a gradation value of 10% or less and a second color indicated by a gradation value of 90% or more.

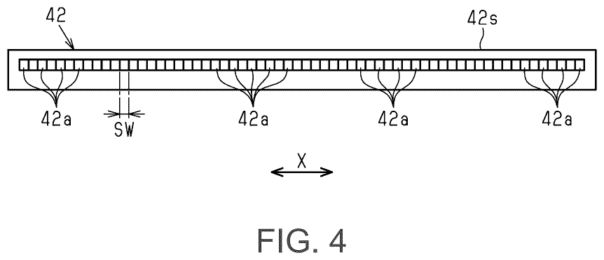

As shown in FIG. 4, the image sensor 42 may be a one-dimensional image sensor including an elongated substrate 42s and a plurality of light receiving elements 42a arranged in a row along the main scanning direction X on the substrate 42s. The image sensor 42 is assembled in the image reading device 11 so that the arrangement direction of the light receiving element 42a is parallel to the main scanning direction X. In the present embodiment, the number of light receiving elements 42a included in the image sensor 42 is A. Here, A is a value equal to or greater than the number of light receiving elements 42a that can be arranged in a range corresponding to the maximum width of the document that can be handled by the image reading device 11. A is, for example, a value in the range of 100 or more and 10,000 or less, but may be a value less than 100 or more than 10,000. In FIG. 5, for convenience of explanation, the number of light receiving elements 42a is depicted as fewer than the actual number.

### Relationship Between Stripe Pattern and Light Receiving Element

The widths W1 and W2 of the black lines BC and the white lines WC shown in FIG. 5 are, for example, the same. Since width W1 and width W2 are the same, the width is set to width W(W=W1=W2). Width W is the width of one or more of the number of light receiving elements 42a. In the present embodiment, the width W is two or more of the number of light receiving elements 42a. The width W is not limited to being a natural number times the width SW of a single portion of the light receiving element 42a, and may be one or more rational number times the width W of one portion of the light receiving element 42a. The width W1 and width W2 may be different values (width W1≠width W2).

Here, the width W values are within a range of 1 to 10 times the width w of one of the light receiving elements 42a, but may be values equal to or greater than 11 times the width w. That is, the width W can be indicated by the number of light receiving elements 42a, and may be a width corresponding to a number of elements ranging from 1 to 10. In the present embodiment, the width W is the number of light receiving elements 42a, for example, adopting a width corresponding to 2 to 6 light receiving elements 42a.

Referring back to FIG. 2, the image reading device 11 includes a control section 50. The control section 50 controls the image reading device 11 when a job for reading an image from the document 14 is input based on an operation signal from the operation section 21 (see FIG. 1) operated by the user or a read instruction signal (read instruction) from the host device 100 (to be described later). When performing reading control, the control section 50 controls the feed motor 37, the transport motor 38, and the reading sections 40A and 40B. The image of the document 14 is read by reading sections 40A and 40B.

### Electrical Configuration of the Image Reading Device 11

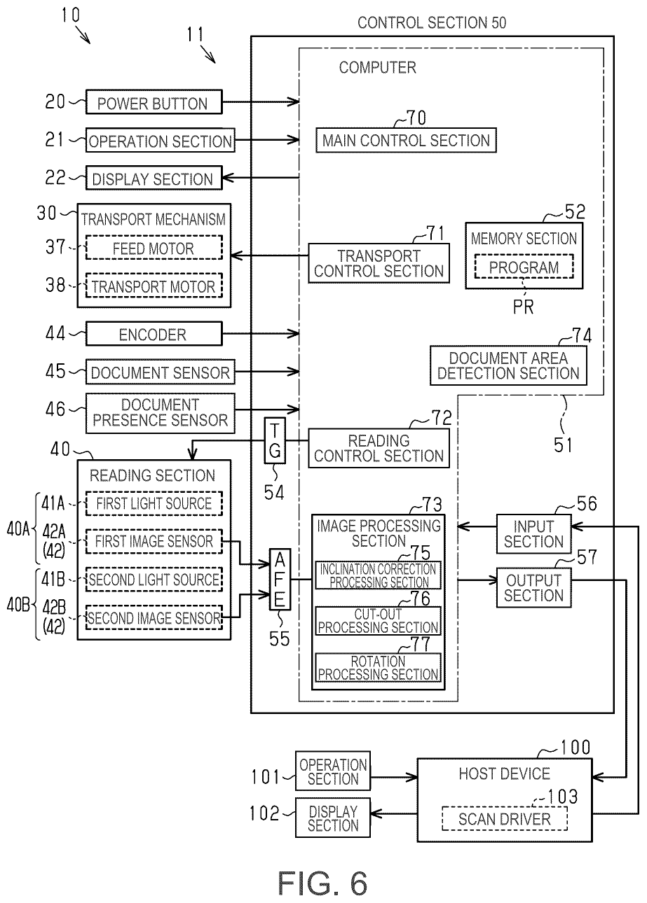

Next, the electrical configuration of the image reading device 11 will be described with reference to FIG. 6.

As shown in FIG. 6, the image reading device 11 is connected to the host device 100 through a communication cable. The host device 100 is, for example, a personal computer (hereinafter also referred to as a “PC”). N/A The host device 100 includes an operation section 101 and a display section 102 electrically connected to the main body of the host device 100. The host device 100 includes a scan driver 103 made of software therein by installation of a scan driver program. The scan driver 103 has a function of instructing the image reading device 11 to read the document 14. The scan driver 103 transmits the read instruction information (scan job data) including the read condition information and various commands specified by the user in the operation of the operation section 101 of the host device 100 to the image reading device 11. Further, the scan driver 103 receives image data of the document 14 from the image reading device 11. The host device 100 is not limited to a PC and may be a portable information terminal (PDA (Personal Digital Assistants)), a tablet PC, a smart device such as a smartphone, or the like.

When the user operates the operation section 21 or the operation section 101 of the host device 100, the reading conditions are set. The reading conditions include document size, reading resolution, reading color (monochrome/color), single-sided reading, double-sided reading, or the like. The document size includes, for example, a A4 size and a B5 size. The reading resolutions include, for example, 300 dpi/600 dpi. The reading color includes monochrome (grayscale) and color.

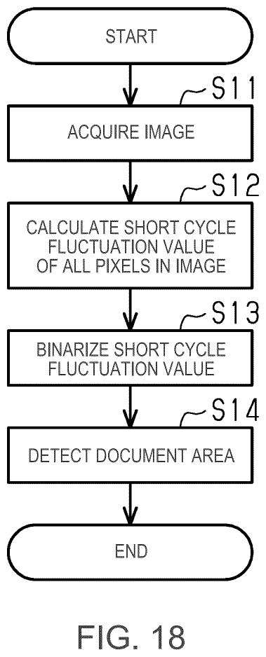

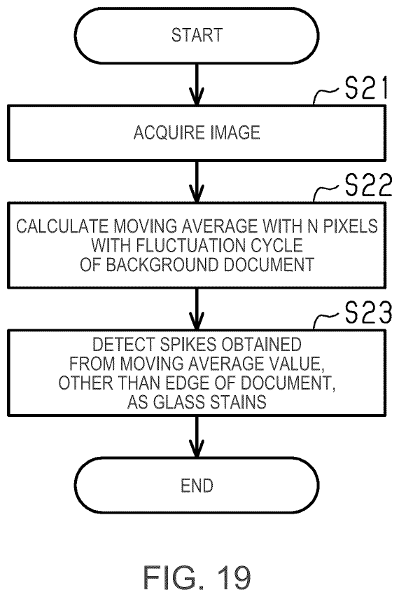

The image reading device 11 includes a control section 50. The control section 50 includes a computer 51 made of a microprocessor or the like. The computer 51 includes a memory section 52 comprising a RAM, a nonvolatile memory, or the like. The memory section 52 stores a program PR. The program PR includes programs shown in flowcharts of FIGS. 18 and 19. The control section 50 is not limited to one that performs software processing for all processes executed by itself. For example, the control section 50 may include a dedicated hardware circuit (for example, an application specific integrated circuit (ASIC)) that performs hardware processing for at least a part of the processing executed by the control section 50. That is, the control section 50 may be configured as circuitry including one or more processors that operate in accordance with a computer program (software), one or more dedicated hardware circuits that execute at least a portion of various processes, or a combination thereof. The processor includes a CPU and memory, such as RAM and ROM, and the memory stores program code or instructions configured to cause the CPU to perform processes. Memory or computer-readable medium includes any available medium that can be accessed by a general purpose or special purpose computer.

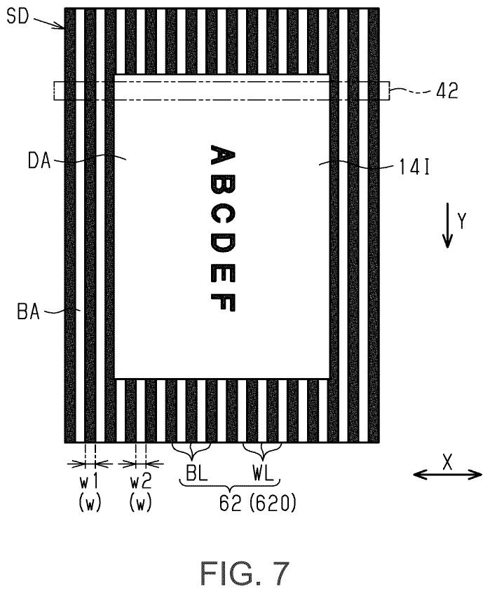

The control section 50 includes an input section 56 consisting of an input interface, and an output section 57 consisting of an output interface. The input section 56 inputs various data and signals from the host device 100. The output section 57 outputs the image data SD (see FIG. 7) read by the image reading device 11 to the host device 100.

Furthermore, the control section 50 includes a timing generator 54 (hereinafter also referred to as “TG 54”). N/A TG 54 outputs a pulse signal that defines various operation timings including a read operation to image sensor 42A and 42B. The control section 50 further includes an analog front end 55 (hereinafter also referred to as “AFE 55”). N/A AFE 55 performs an analog/digital conversion (A/D conversion) on the pixel signals input from image sensor 42A and image sensor 42B.

The computer 51 includes a main control section 70, a transport control section 71, a reading control section 72, an image processing section 73, and a document area detection section 74 as functional portions formed of software which is internally configured by executing the program PR. The main control section 70 generally controls the image reading device 11.

The transport control section 71 feeds the document 14 set on the document support 13 one sheet at a time by driving and controlling the feed motor 37 and the transport motor 38. The document 14 is transported at a predetermined speed along the transport path by the rotation of each of the feed roller 33, the feed roller pair 34, the transport roller pair 35, and the discharge roller pair 36. The document 14 is transported through the reading area SA in the transport path 29 at a reading speed corresponding to the reading resolution (for example, 300/600 dpi). For example, when the reading resolution is a relatively high first reading resolution (for example, 600 dpi), the document 14 is transported at a low speed. On the other hand, when the reading resolution is a relatively low second resolution (for example, 300 dpi), the document 14 is transported at a high speed.

The reading control section 72 controls the reading section 40 via the TG 54. The reading section 40 reads an image of document 14. In particular, the reading control section 72 outputs a pulse signal that defines the operation timing of the reading operation to the image sensor 42 to the TG 54. The reading control section 72 controls the light emission of the light source 41 via a light source driving unit (not shown) and causes the light source 41 to irradiate the reading area SA with light.

The image processing section 73 inputs the digital signal of the image read by the reading section 40 via the AFE 55. The image processing section 73 performs known correction processing such as shading correction on image data based on the input digital signal, and generates image data SD of the document 14. The image processing section 73 performs various corrections such as gamma correction in addition to the shading correction. Further, from the read data, the image processing section 73 generates image data of the document before converting it to the specified format. The output section 57 transmits the file that was generated by converting the image data into a specified format by the image processing section 73, to the host device 100 connected through a communication cable (not shown).

The document area detection section 74 performs a process of detecting the document area DA in the image data SD. The document area detection section 74 detects the document area DA by distinguishing between the document area DA and the background area BA based on the image data SD. Details of the document area detection section 74 will be described later.

The image processing section 73 performs predetermined processing on the image data SD obtained by the reading section 40 reading the document 14. The image processing section 73 includes an inclination correction processing section 75, a cut-out processing section 76, and a rotation processing section 77. In addition, since each process of the reading document 14 by the two reading sections 40 is basically the same process, the front side and the back side are handled as the image data SD without being distinguished from each other in the following.

The inclination correction processing section 75 performs inclination correction processing for correcting the inclination of the document area DA detected by the document area detection section 74.

The cut-out processing section 76 performs cut-out processing to cut out the document area DA from the image data SD. The image data of document 14I (see FIG. 7) is generated by this cutting process.

The rotation processing section 77 performs rotation processing to rotate the image data of the document 14I. The orientation of the image data of document 14I is aligned by the rotation process.

The computer 51 executes a program PR which is stored in the memory section 52 and is shown in flowcharts of FIGS. 18 and 19. In the present embodiment, the document area detection section 74 is configured by the computer 51 that executes the document area detection process shown in FIG. 18. In this case, the document area detection section 74 is configured as software. The processing contents of the program PR may be written in an electronic circuit such as an ASIC. In this case, the document area detection section 74 is configured as hardware.

### About Image Data

Next, an image read by the image sensor 42 will be described with reference to FIG. 7. FIG. 7 illustrates image data SD (also referred to as an “image SD”) read by the image sensor 42. The image data SD includes a document area DA and a background area BA. The document area DA is an area where the document 14I is located in the image data SD of the read document 14. The background area BA is a background area other than the document area DA in the image (read range). In the present embodiment, in the background area BA, a stripe pattern 62 is formed by reading black lines BC and white lines WC drawn on the read surface 43a of the background plate 43. The stripe pattern 62 appearing in the background area BA is formed by black lines BL and white lines WL, which extend along the sub-scanning direction Y, being alternately arranged in the main scanning direction X. That is, the stripe pattern 62 is a vertical stripe pattern 620 in which stripes extend along the sub-scanning direction Y. In FIG. 7, the image sensor 42 is indicated by two dot chain line. The image sensor 42 reads the background plate 43 as the background forming section 60 as a background including the stripe pattern 62 as an example of a pattern with a specific cycle.

The image data SD shown in FIG. 7 is a dot image formed by a large number of pixels (dots). Each pixel constituting the image data SD has a brightness value corresponding to the received light amount that was read in each scan row by a single light receiving element 42a of the image sensor 42 shown in FIGS. 3 and 4.

The image reading device 11 includes two reading modes, which are a high-resolution mode and a low-resolution mode. In the high-resolution image data SD read in the high-resolution mode, the light receiving amount of one light receiving element 42a corresponds to the brightness value of one pixel in the image data SD. In the low-resolution image data SD read in the low-resolution mode, the average value of brightness value of four pixels (2×2), two in each of two directions XY, corresponds to the brightness value of one pixel in the image data SD. The brightness value of one representative pixel located at a predetermined position among the total four pixels of 2×2 may correspond to the brightness value of one pixel in the low-resolution image data SD.

### About Change in Main Scanning Direction X

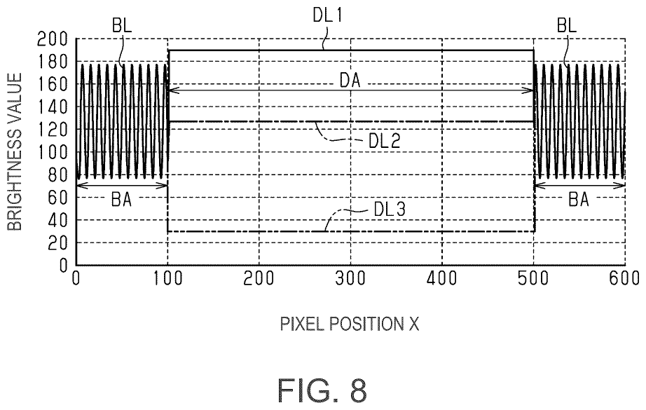

Next, with reference to FIG. 8, the change in the brightness value in the main scanning direction X intersecting the stripe direction in the image data SD will be described. In the graph shown in FIG. 8, the horizontal axis indicates the pixel position X in the main scanning direction X, and the vertical axis indicates the brightness value.

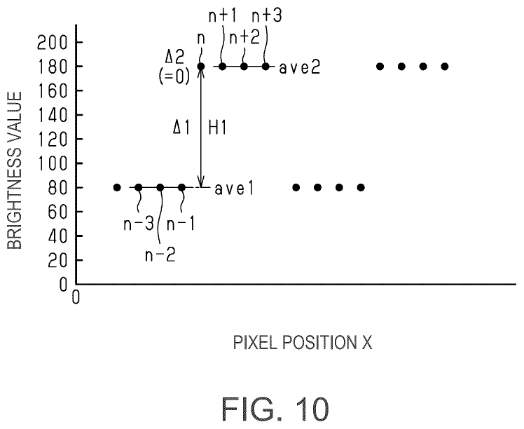

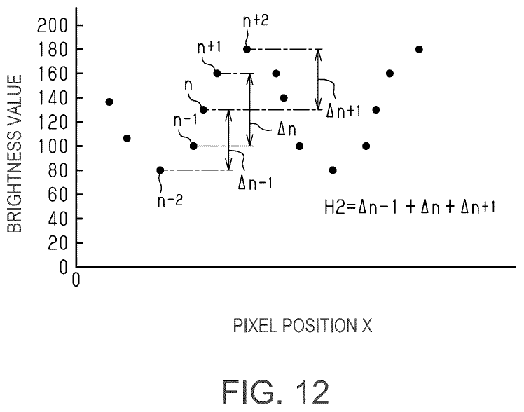

As shown in the graph of FIG. 8, the brightness value in the background area BA fluctuates in a short cycle that is specific to the stripe pattern 62 (short cycle fluctuation). Here, short cycle fluctuation means that the brightness value fluctuates between a low value of the black line BL and a high value of the white line WL in a short cycle corresponding to a short pitch of both lines due to the stripe pattern 61 in the background area BA. In the short cycle fluctuation, when the stripe pattern 62 is clear, the brightness value of each pixel rides on a rectangular wave that changes in a step shape (see FIG. 10) according to the low value of the black line BL and the high value of the white line WL. In the short cycle fluctuation, in a case where the stripe pattern 62 is unclear including blurring, since a gray line of intermediate density appears between the black line BL and the white line WL of the stripe pattern 62, the brightness value of each pixel is on a sine wave which changes in a sine curve shape (see FIG. 12).

On the other hand, in the document area DA indicated by the graph of FIG. 8, the brightness value mainly depends on the color of the background of the document 14. Further, even when a character or a picture is drawn on the document 14, the brightness value does not regularly fluctuate cyclically like the stripe pattern 62 of the background area BA. Therefore, the brightness value is substantially constant depending on the background color of the document 14.

In the graph of FIG. 8, when the color of the background of the document 14I is whitish, the brightness value of the document area DA takes a constant value at a high value indicated by the graph line DL1. When the background color of the document 14I is an intermediate color, the brightness value of the document area DA remains constant at a middle value indicated by the graph line DL2. When the background color of the document 14I is a dark color, the brightness value of the document area DA remains constant at a low value indicated by the graph line DL3.

### Calculation Method of Judgment Value Using Brightness Value in Document Area Detection Process

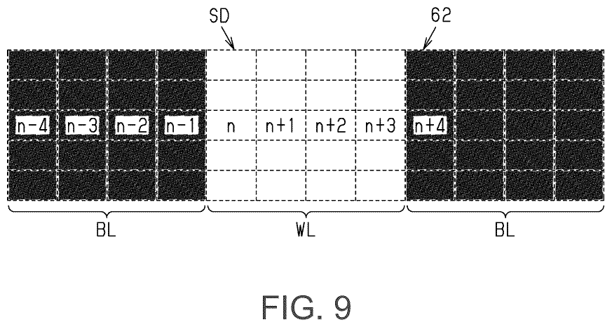

Next, with reference to FIG. 9, a judgment value used for detecting a document area will be described. FIG. 9 is an enlarged view showing a portion of the stripe pattern 62 of the background area BA at the pixel level. FIG. 9, one square partitioned by broken line corresponds to one pixel. In the example shown in FIG. 9, the width W in the stripe pattern 61 corresponds to the width of four light receiving elements 42a. Therefore, in the image data SD shown in FIG. 9, the width of the black lines BL and the width of the white lines WL constituting the stripe pattern 62 each have a width of four pixels.

The control section 50 defines, as a single unit, M-number of pixels, which is a number of 3 or more, that are continuous in the intersecting direction that intersects with the stripe direction (longitudinal direction) of the stripe pattern 62. The control section 50, based on the brightness value of the M-number of pixels as a single unit, obtains for each single unit a short cycle fluctuation value having a value corresponding to the fluctuation amount of the short cycle fluctuation of the brightness value specific to the stripe pattern 62. The control section 50 obtains the short cycle fluctuation value with all pixels of the image data SD as the target pixel. The control section 50 determines the document area DA and the background area BA in the image data SD using the short cycle fluctuation value as a judgment value H. That is, the control section 50 detects the document area DA in the image data SD using the short cycle fluctuation value as the judgment value H.

Here, when the width 2w of the two lines of the black line BL and the white line WL, which are constituent colors of the stripe pattern 62, is one cycle, M-number of pieces, which is the number of pixels of single unit, is more than half the number of pixels N in one cycle (the number in a half cycle) of the stripe pattern 62 (M>N/2).

The control section 50 calculates a judgment value H (short cycle fluctuation value) used for determining the presence or absence of short cycle fluctuation in accordance with a predetermined calculation equation using the brightness values of M-number of continuous pixels including one target pixel in the center in the image data SD. That is, in FIG. 9, while moving one target pixel in order in the intersecting direction (in FIG. 9, in the horizontal direction), it performs a predetermined operation using the brightness value of M-number of continuous pixels including the target pixel to calculate the judgment value H.

Here, the stripe pattern 61 that the background forming section 60 causes the reading section 40 to read is a two-color stripe pattern of light and dark. Specifically, the stripe pattern 61 of the background plate 43 is a two-color stripe pattern of black and white. In a case where the stripe pattern 61 of the background forming section 60 is a two-color stripe pattern of light and dark, if the stripe pattern 62 in the image data SD obtained by reading the document 14 is clear, the stripe pattern 62 in the image data SD also becomes a two-color stripe pattern of light and dark. On the other hand, even when the stripe pattern 61 of the background forming section 60 is a two-color stripe pattern of light and dark, if the stripe pattern 62 in the image data SD obtained by reading the document 14 is unclear, the stripe pattern 62 in the image data SD becomes a gradation of three or more colors of light and dark due to the blurring of the image. Whether the stripe pattern 62 is clear or unclear is generally determined according to the model of the image reading device 11, the reading resolution, and the like.

The control section 50 includes at least one of a first calculation equation in a case where the stripe pattern 62 is clear and a second calculation equation in a case where the stripe pattern 62 is unclear, depending on whether the model has a clear stripe pattern 62 or an unclear stripe pattern 62 in the image data SD when the judgment value H is calculated. The control section 50 includes at least one of a first calculation equation used when the stripe pattern 62 is clear and a second calculation equation used when the stripe pattern 62 is unclear, depending on whether the image data SD is in a high resolution mode in which the stripe pattern 62 is clear or in a low resolution mode in which the stripe pattern 62 is unclear when the judgment value His calculated.

When the stripe pattern 62 in the image data SD is clear, the control section 50 uses the first calculation equation created on the assumption that there is a two-color stripe pattern 62 of light and dark. The control section 50 calculates the first judgment value H1 as the judgment value H using the first calculation equation.

An example of the first calculation equation is shown below. In this example of the first calculation equation, the number of pixels M as a single unit is set to M=7.

H1=max{abs(n−average(n−1,n−2,n−3)),abs(n−average(n+1,n+2,n+3))} (1)

Here, n in the equation indicates the brightness value of the target pixel. For the brightness value of pixels other than the target pixel of the M-number of pixels, whether the pixel is located in the negative direction or the positive direction with respect to the target pixel is indicated by using plus/minus signed numbers. For example, N−2 indicates the brightness value of the second pixel on the minus side with respect to the target pixel. The brightness values of a total of seven pixels are used, that is, the brightness value of the target pixel, the brightness values of the three adjacent pixels on the minus side of the target pixel, and the brightness values of the three adjacent pixels on the plus side of the target pixel are used. The control section 50 calculates the judgment value H1 based on the above equation (1) using the brightness values n−3, n−2, n−1, n, n+1, n+2, and n+3 of the seven pixels.

The control section 50 determines the presence or absence of a short cycle fluctuation specific to the stripe pattern 62 from the comparison result between the judgment value H1 and the threshold value Hs1. That is, if H1>Hs1, it is determined that there is short cycle fluctuation. On the other hand, if H1≤Hs1, it is determined that there is no short cycle fluctuation. In other words, if the judgment value H1 is larger than the threshold value Hs1 (H1>Hs1), the control section 50 determines that the target pixel belongs to the background area BA. On the other hand, if the judgment value H1 is equal to or smaller than the threshold value Hs1 (H1≤Hs1), it is determined that the target pixel belongs to the document area DA. The control section 50 determines that the position at which the presence or absence of the short cycle fluctuation switches is the transition between the background area BA and the document area DA. The control section 50 detects the edge of the document area DA (document 14I) based on the position of the target pixel at which the presence or absence of the short cycle fluctuation switches.

The calculation of the judgment value H1 and the determination using the judgment value H1 may be performed with all the pixels of the image data SD as the target pixels. Further, the calculation of the judgment value H1 and the determination using the judgment value H1 may be performed until the document area DA can be specified, instead of performing on all the pixels of the image data SD. That is, when the document area DA is specified as a result of the determination using the judgment value H1, the calculation and the determination of the judgment value H1 may be terminated.

About calculation equation used when two-color stripe pattern of light and dark.

Here, the first calculation equation applied when the stripe pattern 62 is clear will be described with reference to FIG. 10. The control section 50 calculates a value corresponding to the fluctuation amount of the short cycle fluctuation as the judgment value H1 by the first calculation equation represented by the above equation (1) using the brightness value of the M-number of pixels. Here, the number M is larger than the number of pixels corresponding to a half cycle, which is ½ of the cycle (short cycle) of the stripe pattern 62. In the example shown in FIG. 9, one cycle of the stripe pattern 62 is 8 pixels, which is the sum of 4 pixels of the black line BL and 4 pixels of the white line WL. The half cycle of the cycle of the stripe pattern 62 is 4 pixels. The number M is larger than four pixels (M>4). In the first calculation equation shown in the above equation (1), M=7 is adopted from among the values that satisfy M>4.

As shown in FIG. 10, in the two-color stripe pattern 62 of light and dark, four pixels with a low brightness value belonging to the black line BL and four pixels with a high brightness value belonging to the white line WL are alternately arranged. In the graph of FIG. 10, a pixel with a brightness value n is the target pixel.

In the first calculation equation of the above equation (1), as shown in FIG. 10, with respect to both sides of the target pixel in the intersecting direction (main scanning direction X), the average value is calculated for k (k=(M−1)/2) pixels on one side (minus side) and for k pixels on the other side (plus side). Further, in the first calculation equation, a larger value is selected from two difference values Δ1, Δ2, which are the differences between the respective average values ave1 and ave2 and the brightness value n of the target pixel. In other words, when M is an odd number, the first calculation equation sets, as the judgment value H1, the larger value of the difference Δ1 between the average value ave1 of the brightness values of (M−1)/2 pixels on the minus side with respect to the target pixel and the brightness value n of the target pixel and the difference Δ2 between the average value ave1 of the brightness values of (M−1)/2 pixels on the plus side with respect to the target pixel and the brightness value n of the target pixel. The judgment value H1 is a short cycle fluctuation value indicating a value corresponding to the fluctuation amount of the short cycle fluctuation specific to the stripe pattern 62. The control section 50 performs the determination of the presence or absence of short cycle fluctuation based on the comparison result between the judgment value H1 and the first threshold value Hs1.

The equation (1) is an example in which k pixels (=(M−1)/2) are three pixels. In this case, the judgment value H1 takes a value of 2/3 or more of the difference between the brightness value of black and the brightness value of white. For example, in the example shown in FIG. 10, when the brightness value of black is 80 and the brightness value of white is 180, the judgment value H1 is approximately 67 or more.

On the other hand, it is assumed that the target pixel deviates from the background area BA where the stripe pattern 62 exists and is located at the edge of the document area DA. At this time, the combination of white and black of three pixels on the document area DA side with respect to the target pixel deviates from the combination when the target pixel is in the background area BA. That is, the brightness values of the three pixels on the document area DA side do not satisfy the short cycle fluctuation. The judgment value H1 is a value of approximately 33 or less. Therefore, the first threshold value Hs1 is set to 50, for example. Then, the target pixel is in the background area BA when H 1>Hs 1, and is in the document area DA when H1≤Hs1. The document area DA can be detected from the comparison result between the judgment value H1 and the first threshold value Hs1.

Here, the judgment value H1 based on the brightness values of the pixels in the document area DA will be described with reference to FIG. 8. As can be seen from the graph shown in FIG. 8, in the document area DA, since the brightness value of the pixel mainly depends on the background color of the document 14I, the brightness value is approximately a constant value. When the background color of the document 14I is whitish, the brightness value will be a constant high value as shown by a graph line DL1 indicated by solid line in FIG. 8. When the background color of the document 14I is an intermediate color, the brightness value will be a constant intermediate value as shown by a graph line DL2 indicated by one dot chain line in FIG. 8. When the background color of the document 14I is a dark color, the brightness value will be a constant low value as shown by a graph line DL3 indicated by two dot chain line in FIG. 8. In this way, the brightness value takes a substantially constant value in the document area DA, and there is no or only small short cycle fluctuation. Therefore, the judgment value H1 based on the first calculation equation is 0 (zero) or a small value. At the edge of the document area DA, the brightness value of the pixel in the document area DA is used, so that the judgment value H1 becomes equal to or less than the first threshold value Hs1 (H1≤Hs1). The control section 50 determines, for example, the target pixel of the switch between the presence and absence of short cycle fluctuation as the edge of the document area DA.

The stripe pattern 62 that the background forming section 60 causes the reading section 40 to read is a two-color stripe pattern of light and dark. In the high-speed resolution mode, the document 14 is transported at a low speed. Therefore, the stripe pattern 62 read from the background plate 43 by the reading section 40 is relatively less likely to be blurred. In the stripe pattern 62 in the background area BA, the boundary between the black line BL and the white line WL is clear. The clear stripe pattern 62 is a stripe pattern of two color of light and dark (for example, black and white). Therefore, as shown in FIG. 9, in the case of the two-color stripe pattern 62 of the black line BL and the white line WL, the first calculation equation is used to calculate the judgment value H1.

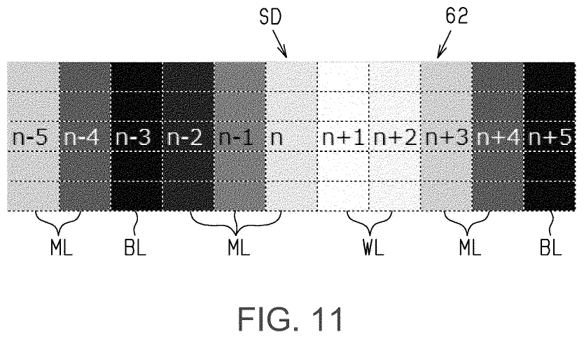

On the other hand, in the low resolution mode, the document 14 is transported at a high speed. Therefore, the stripe pattern 62 read from the background plate 43 by the reading section 40 is likely to be blurred. The image sensor 42 is focused on the read surface of the document 14. Therefore, the stripe pattern 62 obtained by reading the read surface 43a of the background plate 43, which is located separated from the read surface of the document 14, is likely to be blurred. When the background in the image data SD is blurred, as shown in FIG. 11, a stripe pattern in the background area BA forms a line ML having an intermediate density (for example, gray) at the boundary between the black line BL and the white line WL. In this case, the first calculation equation cannot be adopted for detection of the document area DA.

### About Calculation Equation for Stripe Pattern of Three or More Colors of Light and Dark

As shown in FIG. 11, when the stripe pattern 62 is multi-color (three or more colors) including an intermediate density line ML between a black line BL and a white line WL, the second calculation equation is used to calculate the judgment value H (second judgment value H2). An example of the second calculation equation is shown below.

$$H 2 = Δ N - 1 + Δ n + Δ n + 1 \qquad ( 2 )$$

where Δnx=abs (n−x−n+x); (x is an integer)

Here, since x is −1, −0, −1 in the above equation (2), ΔN−1=abs (n−2−n), Δn−abs (n−1−n+1), Δn+1=abs (n−n+2).

In this way, the stripe pattern 61 that the background forming section 60 (background plate 43) causes the reading section 40 to read is a two-color stripe pattern of light and dark. However, there is a case where the background of the document 14I in the image data SD when the reading section 40 reads the document 14 becomes the stripe pattern 62 of three or more colors including one or more colors of intermediate density between two colors of light and dark. In this case, the control section 50 uses a second calculation equation represented by the above equation (2), which is created on the assumption that the stripe pattern 62 in the image data SD is a multicolor stripe pattern of three or more colors. The control section 50 calculates the second judgment value H2 as a judgment value using the second calculation equation.

The second calculation equation uses the brightness value of the M-number of pixels and includes an equation for obtaining the difference value of the brightness value of the two pixels located on both sides of each pixel with respect to M−2-number of pixels closer to the center excluding two pixels at both ends of the M number. The second calculation equation is given by an equation for obtaining a total value obtained by summing the difference values of the brightness values of two pixels on both sides of each pixel in a single unit. The control section 50 determines whether the target pixel belongs to the background area BA or the document area DA based on a comparison result between the second judgment value H2 indicated by the total value and the second threshold value Hs2. The control section 50 determines, for example, the target pixel of the switch between the presence and absence of short cycle fluctuation as the edge of the document area DA.

Here, with reference to FIG. 12, the calculation equation represented by the equation (2) will be described. In the above equation (2), M=5, and five pixels are used as a single unit. A single unit of pixels is a total of five pixels (M=5) including a target pixel, two pixels on the minus side of the target pixel, and two pixels on the plus side of the target pixel. As shown in the graph of FIG. 12, the brightness values of the pixels of the stripe pattern of three or more light and dark colors are generally positioned on a sine curve. In this graph, the pixel with the brightness value n is the target pixel. Then, the pixel with brightness value n−1 and the pixel with brightness value n+1 are adjacent pixels before and after the target pixel. For these three pixels, the differences Δnx of the brightness values n−x and n+x of the pixels before and after each pixel are calculated. Three differences ΔN−1, Δn, Δn+1 are calculated by: ΔN−1−abs (n−2−n), Δn=abs (n−1-n+1), Δn+1−abs (n−n+2). As can be seen from the graph of FIG. 12, when the brightness value point lies on the sine curve, the three difference values ΔN−1, An, Δn+1 take relatively large values. That is, the difference value between at least two of the three values is a relatively large value corresponding to the inclination of a portion of the sine curve having a large gradient. Therefore, the judgment value H2 indicated by the sum (total value) of the three difference values ΔN−1, An, and Δn+1 tends to take a relatively large value. The threshold value Hs2 is set to a value smaller than the minimum value that can be taken by the second judgment value H2 determined from the above equation (2).

In summary, the control section 50 (specifically, the document area detection section 74) executes the following as the document area detection process. The control section 50 uses different calculation equations depending on whether the reading resolution at which the reading section 40 reads the document 14 is a first resolution or a second resolution which is lower than the first resolution. In the case of the first resolution, the control section 50 calculates the first judgment value H1 based on the brightness values of the M-number of pixels by using the first calculation equation represented by the above equation (1). In the case of the second resolution, the control section 50 calculates the second judgment value H2 based on the brightness values of the M-number of pixels by using the second calculation equation represented by the above equation (2). Then, the control section 50 detects the document area DA based on the comparison result between the first judgment value H1 and the first threshold value Hs1 or the comparison result between the second judgment value H2 and the second threshold value Hs2. The control section 50 of this embodiment generates the judgment image data HD in which the brightness value of the image data SD is replaced with the judgment value H. The control section 50 performs a comparison process between the judgment value H and the threshold value Hs by binarizing the judgment image data HD with the threshold value Hs. The details of the binarization process will be described later.

### About Image Processing

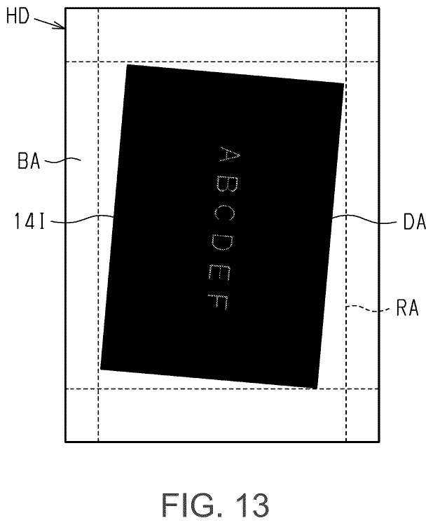

Next, image processing will be described with reference to FIG. 13. FIG. 13 shows the judgment image data HD with the judgment value H as a pixel value. In the judgment image data HD, the background area BA has a high judgment value H, and is therefore close to white. The document area DA has a low judgment value H and is therefore close to black. Since the black characters in the document area DA are out of the short cycle fluctuation specific to the stripe pattern 62, the judgment value His low and, for example, the black characters are gray. As shown in FIG. 13, in the judgment image data HD, the background area BA and the document area DA are divided into regions according to the difference in the judgment value H.

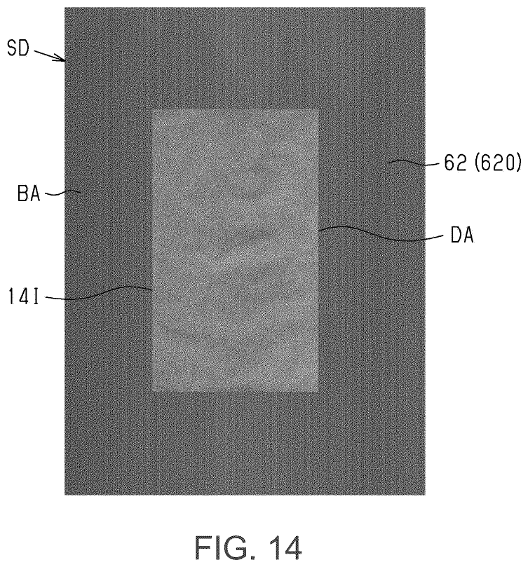

FIG. 14 shows an example of the actual image data SD obtained by reading the document 14. In the image data SD, the background area BA has a stripe pattern 62 with a short cycle. The stripe pattern 62 is, for example, the vertical stripe pattern 620.

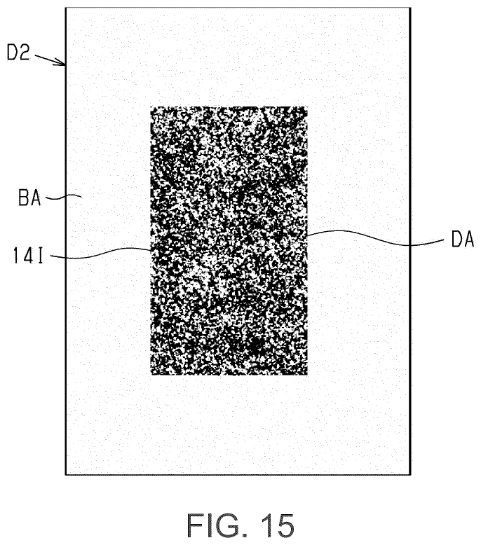

FIG. 15 shows a binarized image D2 obtained by binarizing the judgment image data HD shown in FIG. 14. The binarized image D2 is an image obtained by binarizing the judgment image data HD with the threshold value Hs. The judgment image data HD is short cycle fluctuation value data with a short cycle fluctuation value as a pixel value. Therefore, in the binarized image D2, pixels satisfying H>Hs are shown in white, and pixels satisfying H≤Hs are shown in black.

### Glass Stain Detection Processing

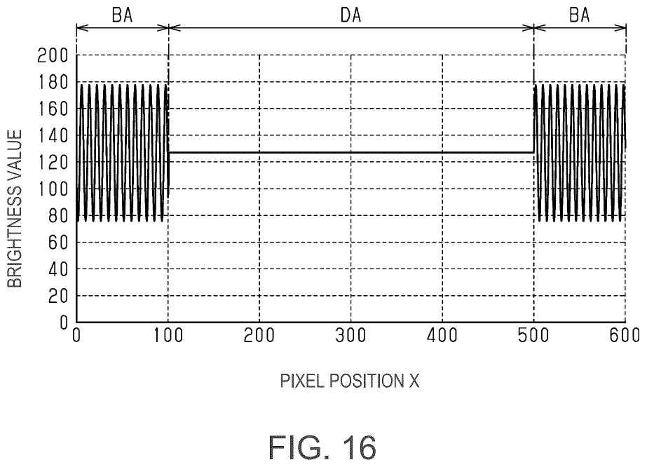

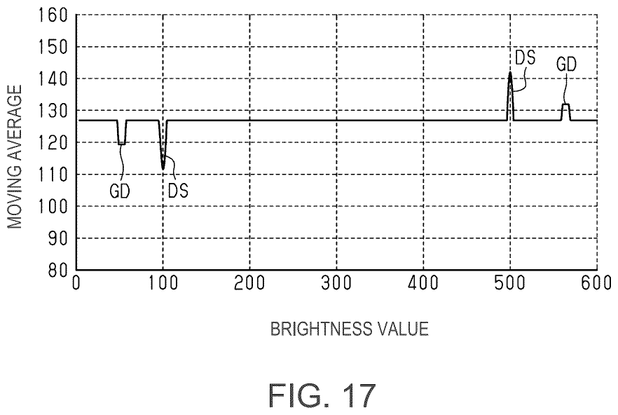

Next, a glass stain detecting process will be described with reference to FIGS. 16 and 17. FIG. 16 is a graph showing brightness values of the image data SD. The horizontal axis is a pixel position x, and the vertical axis is a brightness value. FIG. 17 is a graph showing a moving average value of brightness values of the image data SD.

The control section 50 may obtain a moving average value of the brightness values of the N pixels for a single unit (N) by using the brightness value of each pixel of the image data SD shown in FIG. 16. Here, N is the number of pixels corresponding to the fluctuation cycle of the stripe pattern 62. That is, the stripe pattern 62 has a fluctuation cycle that is the sum of the width w1 of the black line BL and the width w2 of the white line WL. In this embodiment, since w1=w2, the fluctuation cycle is 2w. N is the number of pixels within a range of a distance 2w in a direction intersecting the stripe (for example, the main scanning direction X). In the example shown in FIG. 17, the spike DS at the edge of the document area DA and the spike GD of the glass stain appear in the graph of the moving average line.

The control section 50 detects the spike DS and GD based on the comparison result between the moving average value and a third threshold value. The control section 50 may detect a pixel other than the pixel of the spike DS at the edge of the document area DA among the pixels specified by the spikes DS and GD as the stain on the glass surface of the reading section 40.

### Operations of First Embodiment

Next, the operations of the image reading device 11 will be described.

The user sets the document 14 on the placement surface 13A of the document support 13 of the image reading device 11. The user sets the reading condition to the image reading device 11 by the operation section 21 of the image reading device 11 or the operation section 101 of the host device 100. More specifically, the operation section 21 and operation section 101 are operated to select a reading condition including a reading resolution (for example, 600 dpi/300 dpi or the like), a reading color (color/gray scale), and a reading method (single-sided reading/double-sided reading). The user operates operation section 21 and operation section 101 to instruct the execution of scanning. When the control section 50 receives the scan instruction, it starts reading of the set document 14.

The transport control section 71 in the control section 50 controls the driving of the motors 37 and 38, which are the driving sources of the transport mechanism 30. The document 14 set on the placement surface 13A is fed one sheet at a time in order from the bottommost layer. When the first reading resolution is designated, the control section 50 transports the document 14 at a low speed. When the second reading resolution is designated, the control section 50 transports the document 14 at a high speed.

The reading section 40 reads the document 14 during transportation at the reading position. Specifically, the image sensor 42 reads the document 14. At this time, the image sensor 42 reads document 14 and the background plate 43, which is the background of document 14.

The read signal output from the image sensor 42 is input to the image processing section 73 via the AFE 55 as image data SD. As shown in FIG. 7, the image data SD includes a document area DA and a background area BA. For example, if a skew occurs when the document 14 is transported, the document 14I is inclined as shown in FIG. 13. As a result, the inclination correction process is performed to correct the inclination of the inclined document 14I in the image data SD. In addition, a cutting process and a rotation process of the document 14I are performed. In order to perform the inclination correction process, the cut-out process, and the rotation process, it is necessary to detect the document area DA in which the document 14I is located in the image data SD. In the embodiment, the control section 50 (computer 51) detects the document area DA by executing the program PR of the image area detection process shown in FIG. 18. That is, the document area detection section 74, which is made of software, performs the image area detecting process.

Hereinafter, the image region detection process executed by the control section 50 (computer 51) will be described with reference to FIG. 18.

First, in step S11, the control section 50 acquires an image (image data SD). For example, the computer 51 reads the image data SD illustrated in FIGS. 7 and 14 from the memory section 52. The image data SD includes a document 14I having a background of the stripe pattern 62 with a specific cycle by causing the reading section 40 to read the document 14. The stripe pattern 62 is an example of a pattern with a characteristic cycle.

In step S12, the control section 50 calculates the short cycle fluctuation value of all pixels of the image. The short cycle fluctuation value is a judgment value for determining the presence or absence of a short cycle fluctuation specific to the stripe pattern 62. More specifically, the computer 51 calculates the judgment value H using, as a single unit, three or more M-number of continuous pixels in the intersecting direction, which intersects the stripe direction of the stripe pattern 62 in the image data SD. The computer 51 performs a determination process of determining the presence or absence of a short cycle fluctuation, which is a cyclical fluctuation of brightness value unique to the stripe pattern 62, for a single unit based on the brightness values of the M-number of pixels for a single unit. A direction intersecting with the stripe direction of the stripe pattern 62 corresponds to a direction with the cycle of the pattern. The direction that has the cycle of the pattern is a direction (repetition direction) in which a designated pattern, which is an element of the pattern, is repeated at a specific cycle.

Here, the control section 50 uses a predetermined calculation equation according to whether the stripe pattern 62 in the image data SD is clear or unclear. The calculation equation to be used is determined in advance according to the model and the reading resolution of the image reading device 11. For example, in an example where a calculation equation to be used according to the reading resolution is determined in advance, the control section 50 performs the following processing. When the reading resolution is the first resolution, the control section 50 transports the document 14 at a low speed. Therefore, since the background in the image data SD is not blurred, the background becomes the two-color stripe pattern 62 of light and dark. In this case, for example, the control section 50 calculates the first judgment value H1 as the short cycle fluctuation value on the basis of the first calculation equation represented by equation (1). On the other hand, when the reading resolution is the second resolution, the control section 50 transports the document 14 at a high speed. Therefore, since the background in the image data SD is blurred, the background becomes the stripe pattern 62 of three or more colors of light and dark with gradation. In this case, the control section 50 calculates, for example, the second judgment value H2 as a short cycle fluctuation value based on the second calculation equation represented by the equation (2). The control section 50, for example, generates the judgment image data HD shown in FIG. 13 (short cycle fluctuation value data) by replacing the brightness value of the image data SD with the short cycle fluctuation value.

In step S13, the control section 50 binarizes the short cycle fluctuation value. The control section 50 performs a binarization process for binarizing the judgment image data HD, which has the short cycle fluctuation value as the pixel value, using the threshold value Hs. As a result, the binarized image D2 shown in FIG. 15 is obtained from the image data SD shown in FIG. 14 via the judgment image data HD.

In step S14, the control section 50 detects a document area. As shown in FIG. 15, in the binarized image D2, the background area BA and the document area DA are divided in into monochrome by binary values. The control section 50 detects a document area DA from the binarized image D2. The control section 50 acquires, for example, a rectangular document area DA so as to include the outermost pixel of the pixel group indicating the edge of the document area DA.

Here, through the processing of steps S13 and S14, the control section 50 performs a discrimination process of discriminating between the document area DA and the background area BA based on the position at which the presence or absence of the short cycle fluctuation of a plurality of units obtained from the image data SD switches. In this way, the discrimination process may be performed by binarization processing as in the processing of step S13.

As a result of the image area detection processing, the document area DA is detected. Next, the control section 50 performs the inclination correction process, the cut-out process, the rotation process, and the like on the document 14I specified from the document area DA in the image data SD.

Next, the glass stain detecting process will be described with reference to FIG. 19.

First, in step S21, the control section 50 acquires an image (image data SD).

In step S22, the control section 50 calculates a moving average of N pixels, which is the fluctuation cycle of the background stripes. That is, the control section 50 calculates the moving average value using the brightness values of N pixels corresponding to the fluctuation cycle of the stripe pattern 62 in the background area BA. Here, in the case of the two-color stripe pattern, the fluctuation cycle is represented by w1+w2, using the width w1 of the black line BL and the width w2 of the white line WL. When width w1=width w2, the fluctuation cycle is 2w. The number of pixels located within the width of the fluctuation cycle (one cycle) is N. The control section 50 calculates the moving average value using the brightness values of the N pixels. The control section 50 calculates the moving average value for all pixels of the image data SD. As a result, the calculation result of the moving average value shown in FIG. 17 is obtained. As shown in FIG. 17, a plurality of spikes GD and DS appear in the graph of the moving average value.

In step S23, the control section 50 detects the spike obtain from the moving average value other than the edge of the document as a glass stain. As shown in FIG. 17, the spikes include a spike DS indicating the edge of the document 14I and a spike GD indicating a glass stain. Here, the position of the spike DS indicating the edge of the document 14I is obtained in the document area detection process described above. Therefore, the control section 50 detects a spike GD other than a spikes DS among all of the spikes as a glass stain.

As a result of the glass stain detection process, the control section 50 detects a glass stain. Next, the control section 50 displays information such as a message urging the user to clean the glass of the reading section 40 on the display sections 22 and 102.

According to the present embodiment, the following effects can be obtained.

The image reading device 11 includes the reading section 40 configured to read an image of the document 14. The background forming section 60 causes the reading section 40 to read a background including a stripe pattern 61 with a specific cycle. In the image data SD obtained by the reading section 40 reading the document 14, the control section 50 sets, as a single unit, three or more M-number of continuous pixels in the intersecting direction intersecting with the stripe direction of the stripe pattern 62. The control section 50 determines the presence or absence of a short cycle fluctuation, which is a cyclical fluctuation of the brightness value specific to the stripe pattern 62, for each single unit based on the brightness values of the M−number of pixels for each single unit. The control section 50 discriminates between the document area DA and the background area BA based on the position at which the presence or absence of the short cycle fluctuation of a plurality of units obtained from the image data SD switches. According to this configuration, the presence or absence of the short cycle fluctuation of the stripe pattern 62 is determined for each M-number of pixel units (a single unit), and the document area DA and the background area BA are discriminated based on the position where the presence or absence of the short cycle fluctuation switches. Therefore, the document area DA can be detected with high accuracy.

(1-2) The number of pixels of a single unit is M, which is larger than the number of pixels of a half cycle of the stripe pattern 62. The control section 50 sequentially moves one target pixel in the image data SD in the intersecting direction, and performs a predetermined calculation using the brightness values of the M-number of pixels including the target pixel, and calculates a judgment value H used to judge the presence or absence of the short cycle fluctuation. The control section 50 determines the presence or absence of the short cycle fluctuation based on the comparison result between the judgment value H and the threshold value Hs, and detects the edge of the document area DA based on the position of the target pixel when the presence or absence of the short cycle fluctuation switches.

According to this configuration, the pixel position where the presence or absence of the short cycle fluctuation switches can be detected from the comparison result between the judgment value H obtained by the calculation using the brightness values of the M-number of pixels and the threshold value Hs. Therefore, the document area DA can be detected with high accuracy by calculation using the value of the image data SD.

(1-3) The control section 50 uses a calculation equation (equation (1) and equation (2)) that use the brightness value of the M-number of pixels to calculate a value corresponding to the magnitude of the fluctuation amount of the short cycle fluctuation as the judgment value H. According to this configuration, the judgment value H becomes a large value corresponding to the fluctuation amount in the background area BA where there is short cycle fluctuation, and the judgment value H becomes a small value in the document area DA where there is no short cycle fluctuation. Therefore, the document area DA can be detected with high accuracy from the comparison result between the judgment value H and the threshold value Hs.

(1-4) The stripe pattern 61 that the background forming section 60 causes the reading section 40 to read is a two-color stripe pattern of light and dark. The control section 50 calculates the first judgment value H1 as the judgment value H by using the first calculation equation represented by the equation (1) created on the premise that the stripe pattern 62 in the image data SD is two-color stripes of two colors of light and dark. According to this configuration, in the case where the background stripe pattern 62 in the image data SD is two-color stripes of two colors of light and dark, the document area DA can be detected with high accuracy from the comparison result between the first judgment value H1 and the threshold value Hs1.

(1-5) M is an odd number. The calculation equation (equation (1)) is given by an equation for selecting a larger value of two difference values, which are differences between the brightness value of the target pixel and the average values of k (k−(m−1)/2) pixels on one side of the target pixel in the intersecting direction and k pixels on the other side. The control section 50 determines the presence or absence of the short cycle fluctuation based on the comparison result between the judgment value H1 and the first threshold value.

According to this configuration, in the case where the background stripe pattern 62 in the image data SD is two-color stripes of two colors of light and dark, the document area DA can be detected with high accuracy from the comparison result between the first judgment value H1 and the threshold values. (1-6) The stripe pattern 61 that the background forming section 60 causes the reading section 40 to read is a two-color stripe pattern of light and dark. The control section 50 calculates a second judgment value H2 as the judgment value H using a second calculation equation created on the premise that the stripe pattern 62 in the image data SD is multicolors of stripes of three or more colors including one or more colors of intermediate density between the two colors of light and dark.

According to this configuration, when the stripe pattern 62 in the image data SD is multicolors of stripes of three or more colors of light and dark, the document area DA can be detected with high accuracy from the comparison result between the second judgment value H2 and the threshold value Hs2.

(1-7) The second calculation equation in the equation (2) is given by the equation that uses the brightness values of the M-number of pixels and calculates the total value by summing, by single units, the difference value of brightness values of the two pixels located on both sides of each of the M−2-number of pixels, excluding the two pixels at both ends of the M-number of pixels. The control section 50 determines whether the target pixel belongs to the background area BA or the document area DA based on a comparison result between the second judgment value H2 indicated by the total value and the second threshold value Hs2.

According to this configuration, when the stripe pattern 62 in the image data SD is multicolors of stripes of three or more colors of light and dark, the document area DA can be detected with high accuracy from the comparison result between the second judgment value H2 and the threshold value Hs2.

(1-8) The control section 50 obtains a moving average value of the brightness values of the M-number of pixels for each single unit. Among pixels specified based on a comparison result between the moving average value and a third threshold value, the control section 50 detects a pixel other than a pixel at an edge of the document area DA as a stain on the glass surface, which is the reading surface of the reading section 40. According to this configuration, a stain of the glass surface which is the reading surface of the reading section 40 can be detected.

(1-9) The background forming section 60 is a background plate 43 having a vertical stripe pattern 620 with stripes extending along the sub-scanning direction Y of the reading section 40 as the stripe pattern 61. According to this configuration, in the sheet feed type image reading device, the document area DA can be detected with high accuracy without being affected by a vertical line caused by stain on the glass surface.

(1-10) The stripe pattern 61 that the background forming section 60 causes the reading section 40 to read includes black and white. According to this configuration, since the stripe pattern 61 includes black and white, the fluctuation amount of the short cycle fluctuation is large. Therefore, the document area DA can be detected with high accuracy.

(1-11) When the reading resolution at which the reading section 40 reads the document 14 is the first resolution, the control section 50 calculates the first judgment value H1 based on the brightness values of the M-number of pixels using the first calculation equation (equation (1)). When the reading resolution is the second resolution, which is lower than the first resolution, the control section 50 calculates the second judgment value H2 based on the brightness values of the M-number of pixels using the second calculation equation (equation (2)). According to this configuration, the document area DA in the image data SD can be detected with high accuracy regardless of the difference in the reading resolution.

(1-12) The document area discrimination method in the image reading device 11 discriminates between the document area DA and the background area BA in the image data SD read by a reading section 40, which is configured to read an image of a document 14. This document area discrimination method includes the following processes (a) to (c). (a) Acquiring image data SD of the document 14 having a stripe pattern 62 with a specific cycle as a background by causing the document 14 to be read by the reading section 40. (b) Determining, for each single unit, presence or absence of a short cycle fluctuations, which is a cyclical fluctuation of the brightness value specific to the stripe pattern 62 based on brightness value of M-number of pixels in each single unit, wherein a single unit is M-number of pixels that are three or more pixels continuous a cross direction that intersects with the direction of the stripes of the stripe pattern 62 in the image data SD. (C) Discriminating the document area DA and the background area BA based on a position where the presence or absence of a short cycle fluctuation of a plurality of units obtained from the image data SD switches. According to this method, the document area DA in the image data SD can be detected with high accuracy.

The program PR is executed by the computer 51 of the image reading device 11 including the reading section 40m which is configured to read an image of the document 14. The program PR is executed by the computer 51 in order to distinguish between the document area DA and the background area BA in the image data SD read by the reading section 40. The program PR causes the computer 51 to execute the following processes (a) to (c). (a) The document 14 is read by the reading section 40, and the image data SD of the document 14I having the stripe pattern 62 with a specific cycle as a background is read from the memory section 52. (b) Performing a determination process of determining, for each single unit, presence or absence of a short cycle fluctuation, which is a cyclical fluctuation of the brightness value specific to the stripe pattern 62, based on brightness value of M-number of pixels in each single unit, wherein M-number of pixels that are three or more pixels continuous in a direction that intersects the stripe direction of the stripe pattern 62 in the image data SD are set as a single unit. (c) Performing a discrimination process of discriminating the document area DA and the background area BA are based on a position where the presence or absence of the short cycle fluctuation of a plurality of units obtained from the image data SD switches It is possible to detect the document area DA from the image data SD with high accuracy by causing the computer 51 to execute the program PR.

### Second Embodiment

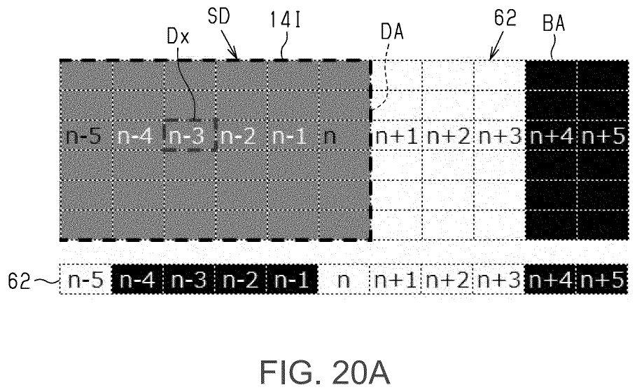

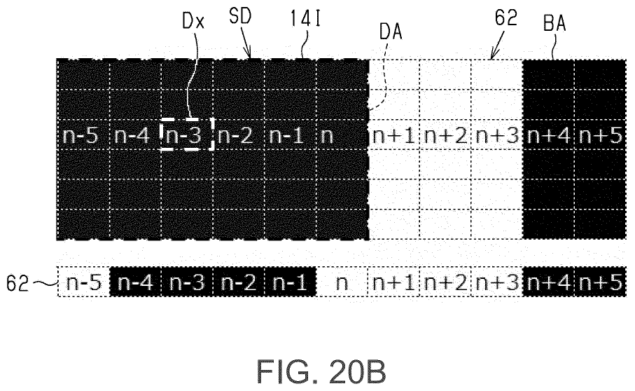

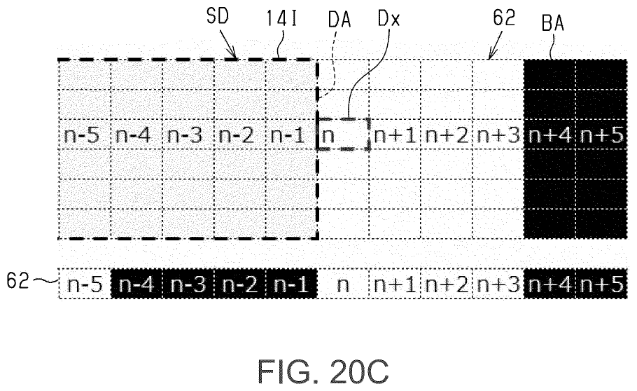

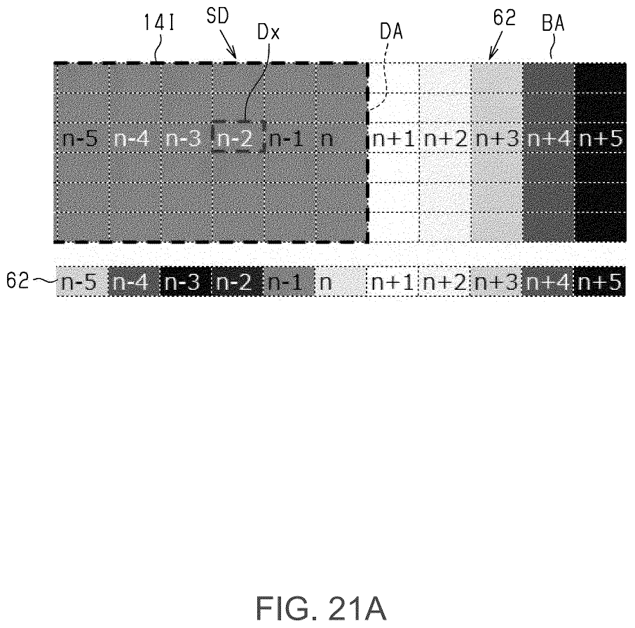

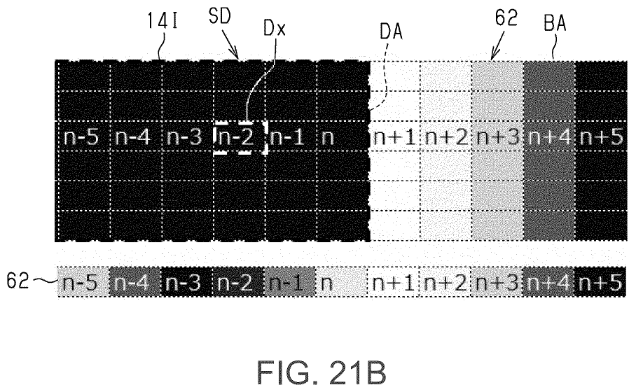

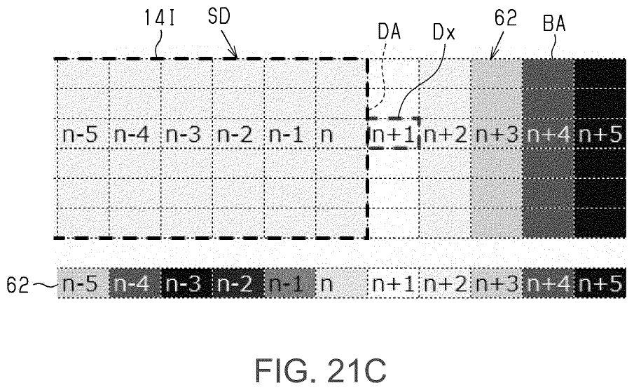

Next, a second embodiment will be described with reference to FIGS. 20A to 20C and FIGS. 21A to 21C. The second embodiment is different from the first embodiment in the position to be detected as the edge of the document area DA. In detail, in the image area detection process, the determination is performed while moving the target pixels in order using M-number of pixels as a single unit. Therefore, after the target pixel reaches the edge of the document area DA, the presence or absence of the short cycle fluctuation may be switched with a delay of a predetermined number of pixels. The deviation of the detection position depends on the relationship between the background color of the document 14I and the constituent colors of the stripe pattern 62. Therefore, in the present embodiment, the positional deviation of the detection position of the edge of the document 14I is corrected by the number corresponding to the combination of the base color of the document and the constituent color of the stripe pattern 62. By this correction, the document area DA is correctly detected. That is, the control section 50 sets, as the edge of the document 14I, a pixel located outside or inside the document area DA by a predetermined number of pixels with respect to the target pixel when the presence or absence of the short cycle fluctuation switches.

First, with reference to FIGS. 20A to 20C, a description will be given of a case where the background is a stripe pattern 62 of two clear colors of light and dark. In the case where the stripe pattern 62 has two clear colors of light and dark, the above equation (1) is used in which a total of seven pixels including three pixels on each side of the target pixel are considered as a single unit.

As shown in FIG. 20A, in a case where the color of the background of the document 14I is a color different from both the white color and the black color of stripes of two colors of light and dark that constitute the stripe pattern 62, a position shifted by three pixels to the inside from the edge of the document area DA is always detected as the detection position Dx satisfying H≤Hs. In other words, the detection position Dx, which is the switching position between the presence and absence of the short cycle fluctuation, is always shifted to the inside from the edge of the document area DA by (M−1)/2 (3 when M=7). Therefore, the control section 50 sets the correction position shifted by three pixels from the detection position Dx to the side toward the outside of the document area DA (the plus side in FIG. 20B) as the edge of the document area DA.

As shown in FIG. 20B, when the color of the background of the document 14I is the same as the high-density color (black) of the stripe pattern 62 of two colors of light and dark (white and black), a position shifted inward by three pixels from the edge of the document area DA is always detected as the detection position Dx satisfying H≤Hs. In other words, the detection position Dx, which is the switching position between the presence and absence of the short cycle fluctuation, is always shifted to the inside from the edge of the document area DA by (M−1)/2 (3 when M=7). Therefore, the control section 50 sets the correction position shifted by three pixels from the detection position Dx to the side toward the outside of the document area DA (the plus side in FIG. 20B) as the edge of the document area DA.

Further, as shown in FIG. 20C, when the color of the background of the document 14I is substantially the same as one of the two light and dark colors (black and white) constituting the stripe pattern 62, the edge of the document area DA may overlap the boundary between the lines of the two colors which are the constituent colors of the stripe pattern 62 in the background. In this case, a position shifted by one pixel to the outside of the edge of the document area DA is detected as the detection position Dx satisfying H≤Hs. Therefore, the control section 50 sets a correction position shifted by one pixel from the detection position Dx to the inside (minus side in FIG. 20C) of the document area DA as the edge of the document area DA. FIG. 20C shows an example in which a document 14I that has a whitish background color overlaps the black line of stripe pattern 62. On the contrary, also in a case where the document 14I of which the background color is blackish overlaps the white line of the stripe pattern 62 similarly, the control section 50 performs correction of shifting the detection position Dx to the inside of the document area DA by one pixel.

Next, with reference to FIGS. 21A to 21C, a description will be given of a case where the background is an unclear stripe pattern 62 having a gradation of three or more light and dark colors. When the stripe pattern 62 of the background is unclear, the equation (2) described above is used in which a total of five pixels including two pixels on both sides of the target pixel are considered as a single unit. Therefore, depending on the position of the edge of the document 14I with respect to the stripe pattern 62, the detection position Dx may be shifted to the inside of the document area DA by a maximum of two pixels and to the outside of the document area DA by a maximum of one pixel.

In the examples shown in FIGS. 21A and 21B, when the edge of the document 14I with respect to the stripe pattern 62 is at this position, the detection position Dx is shifted by a maximum of two pixels to the inside of the document area DA. In this case, the control section 50 sets the correction position shifted by two pixels from the detection position Dx toward the outside of the document area DA (the plus side in FIGS. 21A and 21B) to be the edge of the document area DA.

Further, in the example shown in FIG. 21C, when the edge of the document 14I with respect to the stripe pattern 62 is at this position, the detection position Dx is shifted by a maximum of one pixel to the outside of the document area DA. In this case, the control section 50 sets the correction position shifted by one pixel from the detection position Dx to the side toward the inside of the document area DA (the minus side in FIG. 21C) to be the edge of the document area DA.

When the image data SD is in grayscale, there is a possibility that some part of the document 14I and the stripe pattern 62 may be the same color. Therefore, the detection position shift of the edge of the document 14I depends only on which position of the stripe pattern 62 that the edge of the document 14I overlaps, regardless of the color of the document 14I. In this case, the control section 50 sets, as the edge of the document area DA, a correction position obtained by shifting the detection position Dx by the number of pixels of the positional shift that depends only on which position of the stripe pattern 62 where the edge of the document 14I lies. In addition, in a case where the background color of the document 14I is a color, when the background color is not the same as either of the two colors of the stripe pattern 62 of the background or any color between those two colors, the detection position Dx is always shifted two pixels inside within the document area DA. In this case, the control section 50 sets the correction position shifted from the detection position Dx toward the outside of the document area DA by two pixels to be the edge of the document area DA.

Therefore, according to image reading device 11 of the second embodiment, the following effects can be further obtained in addition to the effects (1-1) to (1-13) obtained by the image reading device 11 of the first embodiment.

(2-1) The control section 50 sets, as the edge of the document area DA, a pixel located outside or inside by a predetermined number of pixels with respect to the target pixel where the presence or absence of the short cycle fluctuation switches. According to this configuration, the document area DA in the image data SD can be detected with higher accuracy.

The above embodiments can also be modified as shown in the modification examples described below. Further, an appropriate combination of the above-described embodiments and modification examples described below may be used as a further modification example, and an appropriate combination of modification examples described below may be used as a further modification example.

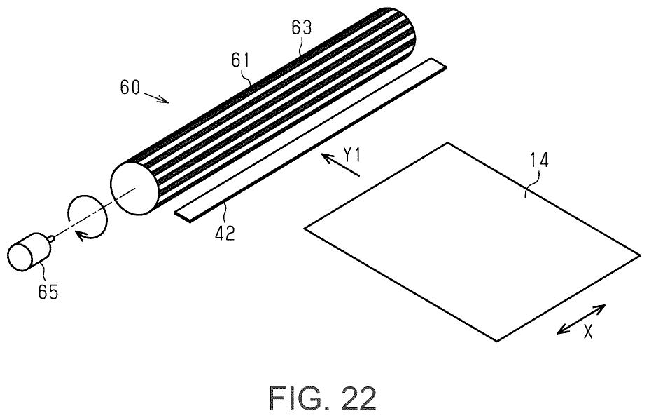

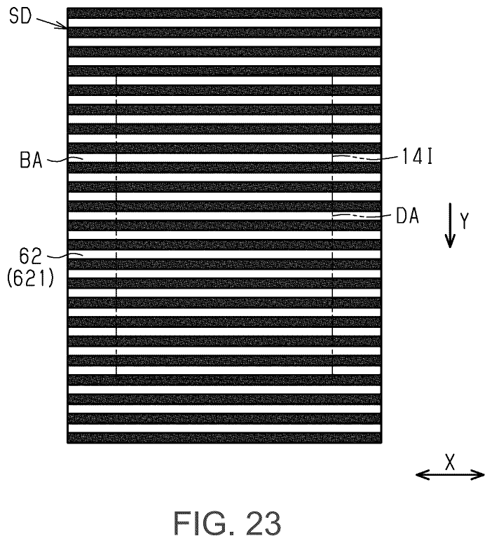

The background forming section 60 is not limited to a configuration in which a stripe pattern 62 is formed as the vertical stripe pattern 620 with a stripe direction parallel to the sub-scanning direction Y. For example, as shown in FIG. 23, a horizontal stripe pattern 621 whose stripe direction is parallel to the main scanning direction X may be formed as the stripe pattern 62 by using the background forming section 60 shown in FIG. 22. As shown in FIG. 22, the background forming section 60 includes a rotatable roller 63. The outer peripheral surface of the roller 63 is formed with a plurality of black lines BC and white lines WC extending in the direction parallel to the axis of the roller 63 (main scanning direction X) and alternately arranged in the circumferential direction. The background forming section 60 includes a motor 65 as a driving source for rotating the roller 63. The driving force of the motor 65 causes the roller 63 to rotate. The image sensor 42 reads the stripe pattern 62 on the outer peripheral surface of the rotating roller 63, thereby reading the stripe pattern 62 consisting of the horizontal stripe pattern extending in the main scanning direction X shown in FIG. 23 as the background of the document 14I. In this way, the stripe pattern 62 read from the background forming section 60 by the reading section 40 is a horizontal stripe pattern 621 in which stripes extend along the main scanning direction of the reading section 40. According to this configuration, in the case of the sheet feed type image reading device 11, since a glass stain becomes vertical lines in the image, the horizontal stripe pattern 621 enables detection of dust of either of the two light and dark colors. For example, when the two colors of light and dark are white and black, dust of both white and black colors can be detected.

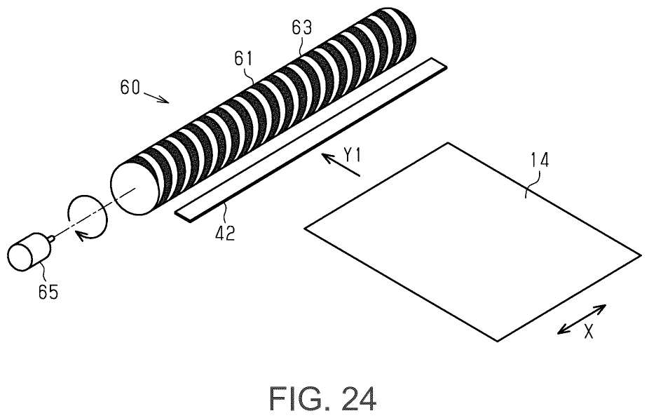

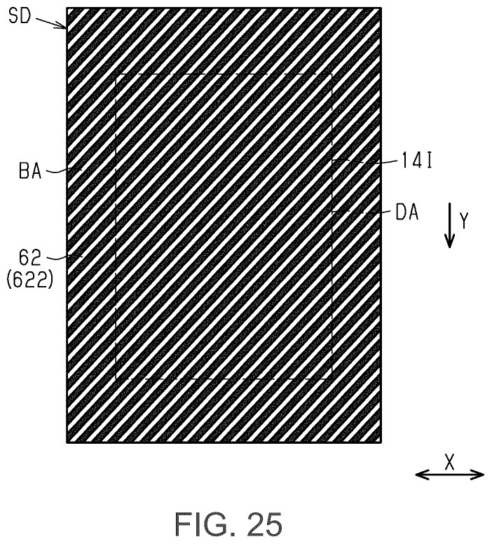

For example, using the background forming section 60 shown in FIG. 24, as shown in FIG. 25, the stripe pattern 62 may be configured as an inclined stripe pattern 622 intersecting in both directions of the main scanning direction X and the sub-scanning direction Y. As shown in FIG. 24, the background forming section 60 includes a rotatable roller 63. On the outer peripheral surface of the roller 63, a spiral stripe pattern 61 is formed in which black lines and white lines are alternately arranged in the axial direction along a spiral path with respect to the axis of the roller 63. The background forming section 60 includes a motor 65 as a driving source for rotating the roller 63. The driving force of the motor 65 causes the roller 63 to rotate. The image sensor 42 reads the spiral stripe pattern 61 formed on the outer peripheral surface of the rotating roller 63, thereby reading the inclined stripe pattern 622 shown in FIG. 25 as the background of the document 14I. In this way, the stripe pattern 62 read from the background forming section 60 by the reading section 40 may be the inclined stripe pattern 622 intersecting both the main scanning direction X and the sub-scanning direction Y of the reading section 40. According to this configuration, since the stripe pattern 62 is the inclined stripe pattern 622 having an angle different from that of the vertical lines or the document 14I caused by a glass stain, the document area DA can be detected with high accuracy, and a glass stain caused by dust or the like can also be detected.

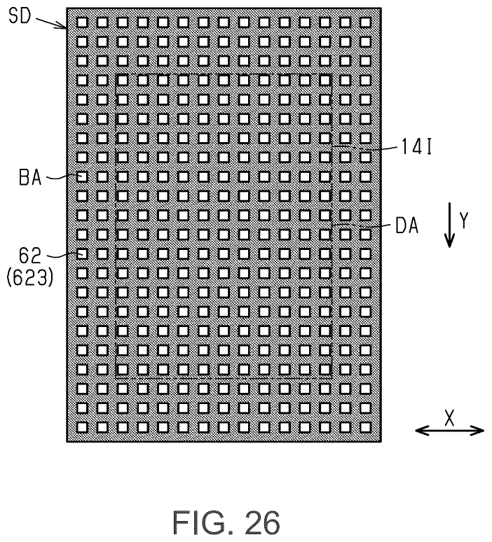

As shown in FIG. 26, the stripe pattern 62 formed as the background of the document 14I in the image data SD may be a grid pattern 623. In the example shown in FIG. 26, the grid pattern 623 includes vertical stripes in which high-density lines and low-density lines extending in the sub-scanning direction Y are alternately arranged in the main scanning direction X, and horizontal stripes in which high-density lines and low-density lines extending in the main scanning direction X are alternately arranged in the sub-scanning direction Y. Further, the grid pattern 623 may be an inclined grid pattern 623 in which the high-density lines and the low-density lines are obliquely inclined with respect to the two directions of the main scanning direction X and the sub-scanning direction Y.

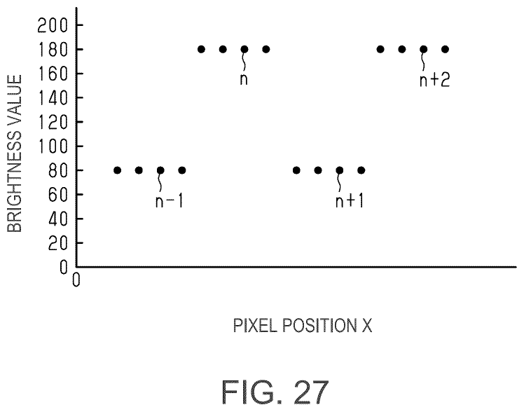

In order to shorten the processing time in the document area detection processing, the processing may be performed by reducing the resolution. In this case, for example, when 4×4 pixels are converted into 1 pixel in order to reduce the resolution, thinning processing is preferable instead of averaging processing. For example, in the thinning process, the brightness value of one representative pixel among 4×4 pixels may be converted to the brightness value of one pixel. For example, as shown in FIG. 27, by thinning out one representative pixel for every four pixels in the main scanning direction X before the resolution is reduced, the calculation based on the calculation equation of the above-mentioned equation (1) or the calculation equation of the above-mentioned equation (2) may be performed using the brightness values n−1, n, n+1, etc. of the representative pixels. According to this configuration, a variation in judgment value H is suppressed compared to a configuration in which an average value of brightness values of 4×4 is used. Therefore, the document area DA can be detected with high accuracy.

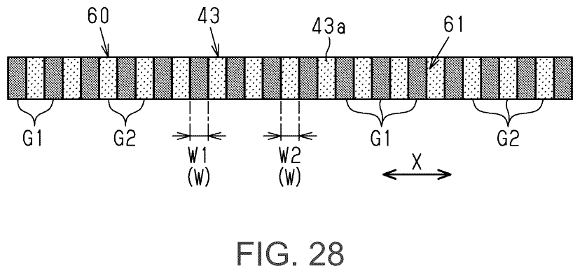

As shown in FIG. 28, the stripe pattern 61 provided on the read surface 43a of the background plate 43 may be formed by alternately arranging high-density lines and low-density lines. The high-density line and the low-density line are not limited to the combination of the black line BC and the white line WC. For example, as shown in FIG. 28, the stripe pattern 61 that the background forming section 60 causes the reading section 40 to read may include a high-density line G1 of a first gray color and a low-density line G2 of a second gray color whose density is thinner than that of the first gray color. The color of the highest density may be gray. Since the color of the highest density of the stripe pattern 61 is gray and not black, it is possible to reduce conspicuousness of strike through of the stripe pattern 61, which is when the stripe pattern 61 of the background forming section 60 can be read through the document 14 on the opposite surface.

The stripe pattern 61 provided in the background forming section 60 is not limited to two colors, and may be a plurality of colors of three or more colors. For example, a three-color stripe pattern may be used. Further, a four or five color stripe pattern may be used. In this case, by calculating the judgment value H2 (short cycle fluctuation value) using the calculation equation (2), the document area DA can be detected based on the comparison result between the judgment value H2 and the second threshold value Hs2.

The thickness or interval of the lines constituting the stripe pattern 61 may be different for each density or color. For example, the width W1 of the black line BC and the width W2 of the white line WC constituting the stripe pattern 61 provided on the background plate 43 or the read surface 43a of the roller 63 may be different from each other. Further, in the stripe pattern 61 of three or more different colors, the line width may vary for each density or color.

The above equation (1) is an example of a calculation equation (first calculation equation) used in the case of the two-color stripe pattern 62 of light and dark, and another first calculation equation may be used. In short, it may be a calculation equation that can calculate a value of a size corresponding to the fluctuation amount of the two-color stripe pattern 62 of light and dark.

The above-mentioned equation (2) is an example of a calculation equation (second calculation equation) used in the case of stripe pattern 62 of multiple colors (gradation) of three or more colors of light and dark, and another second calculation equation may be used. In short, the equation may be a calculation equation capable of calculating the value of a size corresponding to the fluctuation amount of the short cycle fluctuation in the case of the stripe pattern 62 having three or more colors of light and dark.

The stripe pattern 61 on the background forming section 60 side is not limited to alternately repeating light and dark, and may be a multi-level gradation.

The number of pixels M used in the document area detection process may be changed during the detection process.

In each of the above-described embodiments, the determination process of determining, for each single unit, the presence or absence of the short cycle fluctuation, which is the cyclical fluctuation of the brightness value unique to the stripe pattern 62, is the binarization process of binarizing the judgment image data HD having the judgment value H as the pixel value with the threshold value Hs, but this is not a limitation. The control section 50 (computer 51) may use a determination process for determining, for each single unit, the presence or absence of short cycle fluctuation by performing a comparison result between the judgment value H and the threshold value Hs. In this case, the control section 50 may replace the pixel value of the target pixel with a value according to the determination result. For example, it may be replaced with 1 if there is a short cycle fluctuation and it may be replaced with 0 if there is no short cycle fluctuation. Also in this configuration, binary data equivalent to the binarized image D2 can be acquired.

Image reading device 11 may be provided as a part of a multifunction peripheral including a scanner, a printing function, and a copying function. An automatic document feeder (auto sheet feeder) that automatically feeds a document may be provided.

The stripe pattern forming section for forming the horizontal stripe pattern 621 parallel to the sub-scanning direction Y shown in FIG. 23 is not limited to the roller type shown in FIG. 22, and may be a belt type. In the case of the belt type, black lines and white lines extending in parallel to a belt rotation axis may be drawn on an outer peripheral surface of an endless belt.

In the case of forming the inclined stripe pattern 62 (622) shown in FIG. 25, the background forming section 60 is not limited to a roller type. The background forming section 60 may have a configuration in which a background plate (moving body) on which the stripe pattern, including a plurality of black lines and white lines alternately arranged in the main scanning direction X, is drawn reciprocates in the main scanning direction X. With this configuration, it is also possible to form an inclined stripe pattern 62 (inclined stripe pattern 622) as the background of the document 14I in the image SD.

The pattern with a specific cycle is not limited to a stripe pattern. It may be a pattern in which a predetermined pattern (a figure or the like) is repeated at a specific cycle, and the elements of the pattern to be repeated are not limited to lines or the like.

The program PR for document area detection processing shown in the flowchart of FIG. 18 may be executed by the computer of the host device 100. In detail, the program PR shown in FIG. 18 may be included in a scan driver program, or in an application program for adding functions, that is installed in the computer of the host device 100. When the computer of the host device 100 executes the program PR, for example, the scan driver 103 (reading control device) may be configured to include a document area detection section formed of software.

The background forming section 60 is not limited to the configuration including the background plate 43 and the roller 63, and may be of any type as long as it can form the stripe pattern on the background of an image.

The program PR for glass stain detection shown in the flowchart of FIG. 19 may be installed in the computer 51 of the host device 100. In detail, the program PR shown in FIG. 19 may be included in the scan driver program or the application program for adding functions that is installed in the computer 51 of the host device 100. In this case, the computer 51 of the host device 100 executes the program PR, and thus, for example, the scan driver 103 (reading control device) is configured to include a glass stain detection section formed of software.

Image reading device 11 is not limited to a sheet feed type, and may be a flatbed type. A flatbed type of the image reading device includes a carriage that is movable within the main body along the sub-scanning direction (Y direction). The carriage includes a light source and a reading section. The image sensor 42 constituting the reading section is arranged on the carriage so that the arrangement direction of the light receiving elements is parallel to the main scanning direction X. The carriage reciprocates in the sub-scanning direction Y using a scanning motor as a power source. An image of the document 14 set on a glass plate of the document table is read by a light source and a reading section moving together with a carriage. In the image reading device 11 of the flatbed type, the edge (boundary) of the document 14I in the image SD can be detected in the same manner as in the image reading device 11 of the sheet feed type by the document area detection process of the present embodiment. In the case of a flatbed type of the image reading device, the background forming section may be a background plate provided on the back surface of a document table cover that can be opened and closed with respect to the document table. The document table cover can press the document 14 set on the document table at the closed position. When the reading section moves in the sub-scanning direction to read the document on the document table, it reads the stripe pattern of the background plate provided on the back surface of the document table cover as the background of the document. Note that the stripe pattern of the background plate provided on the back surface of the document table cover may be a stripe pattern whose stripe direction is parallel to any one of the main scanning direction X, the sub-scanning direction Y, and an inclined direction intersecting these two directions X and Y.

The image sensor 42 is not limited to a CMOS image sensor, and may be, for example, a MOS (Metal Oxide Semiconductor) image sensor or a CCD (charge coupled device) image sensor.

The image sensor 42 is not limited to a linear image sensor, and may be an area image sensor.

Each functional section in the computer 51 is not limited to being realized by the CPU, but may be realized in hardware using electronic circuits such as ASIC (application specific integrated circuit) and FPGA (field-programmable gate array), or may be realized in both software and hardware.

The material of the document is not limited to paper, and may be a resin film or sheet, a fabric, a metal film, or the like.

Hereinafter, technical ideas grasped from the embodiment and the modification examples will be described together with effects.

(A) An image reading device includes a reading section configured to read an image of a document, a background forming section for causing the reading section to read a background including a pattern with a specific cycle, and a control section, wherein in the image data obtained by the reading section reading the document, three or more M-number of pixels continuous in a direction with the cycle of the pattern are considered as a single unit, and the control section determines the presence or absence of a short cycle fluctuation, which is a cyclical fluctuation of the brightness value specific to the pattern, for each of the single units based on the brightness values of the M pixels for each of the single units, and a document area and a background area are discriminated based on a position where the presence or absence of the short cycle fluctuation of a plurality of units obtained from the image data switches.

According to this configuration, the presence or absence of the short cycle fluctuation of the pattern is determined for each M-number of pixel units (a single unit), and the document area and the background area are discriminated based on the position where the presence or absence of the short cycle fluctuation switches. Therefore, the document area can be detected with high accuracy.

(B) The image reading device according to the above (A) may be such that the pattern is a stripe pattern with the specific cycle, and the direction with the cycle is an intersecting direction intersecting a stripe direction of the stripe pattern.

According to this configuration, the presence or absence of the short cycle fluctuation of the stripe pattern is determined for each M-number of pixel units (a single unit), and the document area and the background area are discriminated based on the position at which the presence or absence of the short cycle fluctuation switches.

Therefore, the document area can be detected with high accuracy.

(C) The image reading device according to (B) may be such that the number of pixels of the single unit is M, which is larger than a number of pixels in a half cycle of the stripe pattern, the control section sequentially moves one target pixel in the image data in the intersecting direction, and performs a predetermined calculation using the brightness values of the M-number of pixels including the target pixel, and calculates a judgment value used to judge the presence or absence of the short cycle fluctuation, and the control section determines the presence or absence of the short cycle fluctuation based on a comparison result between the judgment value and a threshold value, and detects the edge of the document area based on the position of the target pixel when the presence or absence of the short cycle fluctuation switches.

According to this configuration, the pixel position where the presence or absence of the short cycle fluctuation switches can be detected from the comparison result between the judgment value obtained by the calculation using the brightness values of the M-number of pixels and the threshold value. Therefore, the document area can be detected with high accuracy by the calculation using the values of the image data.

(D) The image reading device according to (C) may be such that the control section uses a calculation equation that use the brightness values of the M-number of pixels to calculate, as the judgment value, a value corresponding to the magnitude of the fluctuation amount of the short cycle fluctuation.

According to this configuration, the judgment value becomes a large value corresponding to the magnitude of the fluctuation amount in the background area having the short cycle fluctuation, and the judgment value becomes a small value in the document area having no short cycle fluctuation. Therefore, the document area can be detected with high accuracy from the comparison result between the judgment value and the threshold value.

(E) The image reading device described in (C) or (D) may be such that the stripe pattern that the background forming section causes the reading section to read is a two-color stripe pattern of two colors of light and dark and the control section calculates a first judgment value as the judgment value using a first calculation equation created on the premise that the stripe pattern in the image data is two-color stripes of two colors of light and dark.

According to this configuration, in a case where the stripe pattern of the background in the image data is two-color stripes of two colors of light and dark, the document area can be detected with high accuracy from the comparison result between the first judgment value and the threshold value.

(F) The image reading device according to (E) may be such that M is an odd number, the first calculation equation is given by an equation for selecting a larger value of two difference values, which are differences between an average value of, amongst pixels on both sides of the target pixel in the intersecting direction, k (k−(M−1)/2) pixels on one side and k pixels on the other side and a brightness value of the target pixel, and the control section determines the presence or absence of the short cycle fluctuation based on a comparison result between the judgment value and a first threshold value.

According to this configuration, in a case where the stripe pattern of the background in the image data is two-color stripes of two colors of light and dark, the document area can be detected with high accuracy from the comparison result between the first judgment value and the threshold value.

(G) In the image reading device according to (C) or (D) may be such that the stripe pattern that the background forming section causes the reading section to read is a two-color stripe pattern of two colors of light and dark and the control section calculates a second judgment value as the judgment value using a second calculation equation created on the premise that the stripe pattern in the image data is multicolors of stripes of three or more colors including one or more colors of intermediate density between the two colors of light and dark.

According to this configuration, in a case where the stripe pattern of the background in the image data is multicolors of stripes of three or more colors of light and dark, it is possible to detect the document area with high accuracy from the comparison result between the second judgment value and the threshold value.

(H) The image reading device according to (G) may be such that the second calculation equation is given by the equation that uses the brightness values of the M-number of pixels and calculates a total value by summing, for the single unit, the difference value of brightness values of two pixels located on both sides of each of the M−2-number of pixels, excluding the two pixels at both ends of the M-number of pixels and the control section determines whether the target pixel belongs to the background area or the document area based on the comparison result between the second judgment value indicated by the total value and the second threshold value.

According to this configuration, in a case where the stripe pattern of the background in the image data is multicolors of stripes of three or more colors of light and dark, it is possible to detect the document area with high accuracy from the comparison result between the second judgment value and the threshold value.

(I) The image reading device according to any one of (C) to (H) may be such that the control section obtains a moving average value of brightness values of the M-number of pixels for each single unit, and detects, as a stain on a glass surface, which is a reading surface of the reading section, a pixel other than a pixel at an edge of the document area among pixels specified based on a comparison result between the moving average value and a third threshold value.

According to this configuration, it is possible to detect the stain of the glass surface, which is the reading surface of the reading section.

(J) The image reading device according to any one of (B) to (I) may be such that the background forming section is a background plate having a vertical stripe pattern in which stripes extend along a sub-scanning direction of the reading section.

According to this configuration, it is possible to detect the document area with high accuracy without being affected by stain of the glass surface.

(K) The image reading device according to any one of (B) to (J) may be such that the stripe pattern that the background forming section causes the reading section to read includes black and white.

According to this configuration, since the stripe pattern includes black and white, the fluctuation amount of the short cycle fluctuation is large. Therefore, the document area can be detected with high accuracy.

(L) The image reading device according to any one of (B) to (K) may be such that the stripe pattern that the background forming section causes the reading section to read has a maximum density color of gray.

According to this configuration, since the color with the highest density of the stripe pattern is not black but gray, it is possible to reduce the conspicuousness of strike through of the stripe pattern, which is when the stripe pattern of the background forming section can be read through the document on the opposite surface.

(M) The image reading device according to any one of (B) to (I) and (K) may be such that the stripe pattern read from the background forming section by the reading section is a horizontal stripe pattern in which stripes extend along a main scanning direction of the reading section.

According to this configuration, in the case of the image reading device of the sheet feed type, since glass stains becomes vertical lines in the image, dust of either of the two colors of light and dark can be detected as long as it is the horizontal stripe pattern. For example, when the two colors of light and dark are white and black, dust of both white and black colors can be detected.

(N) The image reading device according to any one of (B) to (I) and (K) may be such that the stripe pattern read from the background forming section by the reading section is an inclined stripe pattern intersecting with both a main scanning direction and a sub-scanning direction of the reading section.

According to this configuration, since the vertical line of a glass stain and the inclined stripe pattern are formed at different angles from the document, the document area can be detected with high accuracy, and a glass stain due to dust or the like can also be detected.

The image reading device according to any one of (C) to (N) may be such that when the reading resolution at which the reading section reads the document is a first resolution, the control section calculates a first judgment value based on brightness values of the M-number of pixels using the first calculation equation of (E) and when the reading resolution is a second resolution that is lower than the first resolution, the control section calculates the second judgment value based on brightness values of the M-number of pixels using the second calculation equation of (G).

According to this configuration, the document area in the image data can be detected with high accuracy regardless of the difference in the reading resolution.

(P) The image reading device according to any one of (B) to (O) may be such that the control section sets, as an edge of the document area, a pixel located outside or inside by a predetermined number of pixels with respect to the target pixel where the presence or absence of the short cycle fluctuation switches.

According to this configuration, the document area in the image data can be detected with higher accuracy.

(Q) A document area discrimination method in an image reading device includes discriminating between the document area and the background area in the image data read by a reading section configured to read an image of a document, acquiring image data of the document having a pattern with a specific cycle as a background by causing the document to be read by the reading section, and determining presence or absence of a short cycle fluctuation, which is a cyclical fluctuation in brightness value specific to the pattern, for each single unit and based on brightness value of M-number of pixels in each single unit, wherein three or more M-number of pixels continuous in a direction with the cycle of the pattern in the image data are considered as a single unit, and discriminating between the document area and the background area based on a position where the presence or absence of the short cycle fluctuation of a plurality of units obtained from the image data switches.

According to this method, the document area in the image data can be detected with high accuracy.

(R) A program is a program that causes a computer of an image reading device, which includes a reading section configured to retrieve an image of a document, to determine a document area and a background area in image data read by the reading section, and includes a computer of an image reading device having a reading section configured to read an image of a document is caused to determine a document area and a background area in image data read by the reading section, wherein the program causing the computer to cause the reading section to read the document and retrieve, from a memory section, image data of the document having a pattern with a specific cycle as a background, perform a determination process of determining presence or absence of a short cycle fluctuation, which is a cyclical fluctuation in brightness value specific to the pattern, for each single unit and based on brightness value of M-number of pixels in each single unit, wherein three or more M-number of pixels continuous in a direction with the cycle of the pattern in the image data are considered as a single unit, and perform a discrimination process of discriminating the document area and the background area based on a position where the presence or absence of the short cycle fluctuation of a plurality of units obtained from the image data switches.

By executing this program, the document area can be detected from the image data with high accuracy.

What is claimed is:

1. An image reading device comprising:
a reading section configured to read an image of a document;
a background forming section for causing the reading section to read a background including a pattern with a specific cycle; and
a control section, wherein
in image data obtained by the reading section reading the document, three or more M−number of pixels continuous in a direction with the cycle of the pattern are considered as a single unit,
the control section determines, for each of the single units, a presence or absence of a short cycle fluctuation, which is a cyclical fluctuation in brightness value specific to the pattern, based on brightness values of the M-number of pixels for each of the single units, and
discriminates between a document area and a background area based on a position where the presence or absence of the short cycle fluctuation of a plurality of units obtained from image data switches.

2. The image reading device according to claim 1, wherein
the pattern is a stripe pattern with the specific cycle, and the direction with the cycle is an intersecting direction intersecting a stripe direction of the stripe pattern.

3. The image reading device according to claim 2, wherein
a number of pixels of the single unit is M, which is larger than a number of pixels in a half cycle of the stripe pattern,
the control section sequentially moves one target pixel in the image data in the intersecting direction, and performs a predetermined calculation using the brightness values of the M-number of pixels including the target pixel, and calculates a judgment value used to judge the presence or absence of the short cycle fluctuation, and
the control section determines the presence or absence of the short cycle fluctuation based on a comparison result between the judgment value and a threshold value, and detects an edge of the document area based on the position of the target pixel when the presence or absence of the short cycle fluctuation switches.

4. The image reading device according to claim 3, wherein
the control section uses a calculation equation that use the brightness values of the M−number of pixels to calculate, as the judgment value, a value corresponding to a magnitude of a fluctuation amount of the short cycle fluctuation.

5. The image reading device according to claim 3, wherein
the stripe pattern that the background forming section causes the reading section to read is a two-color stripe pattern of two colors of light and dark and
the control section calculates a first judgment value as the judgment value using a first calculation equation created on a premise that the stripe pattern in the image data is two-color stripes of two colors of light and dark.

6. The image reading device according to claim 5, wherein
M is an odd number,
the first calculation equation is given by an equation for selecting a larger value of two difference values, which are differences between an average value of, amongst pixels on both sides of the target pixel in the intersecting direction, k (k=(M−1)/2) pixels on one side and k pixels on an other side and a brightness value of the target pixel, and
the control section determines the presence or absence of the short cycle fluctuation based on a comparison result between the judgment value and a first threshold value.

7. The image reading device according to claim 3, wherein
the stripe pattern that the background forming section causes the reading section to read is a two-color stripe pattern of light and dark and
the control section calculates a second judgment value as the judgment value using a second calculation equation created on a premise that the stripe pattern in the image data is multicolors of stripes of three or more colors including one or more colors of intermediate density between the two colors of light and dark.

8. The image reading device according to claim 7, wherein
the second calculation equation is given by the equation that uses the brightness values of the M-number of pixels and calculates a total value by summing, for the single unit, a difference value of brightness values of two pixels located on both sides of each of an M−2−number of pixels, excluding the two pixels at both ends of the M-number of pixels and
the control section determines whether the target pixel belongs to the background area or the document area based on the comparison result between the second judgment value indicated by the total value and a second threshold value.

9. The image reading device according to claim 3, wherein
the control section obtains a moving average value of brightness values of the M−number of pixels for each single unit, and detects, as a stain on a glass surface, which is a reading surface of the reading section, a pixel other than a pixel at an edge of the document area among pixels specified based on a comparison result between the moving average value and a third threshold value.

10. The image reading device according to claim 2, wherein
the background forming section is a background plate having a vertical stripe pattern in which stripes extend along a sub-scanning direction of the reading section.

11. The image reading device according to claim 2, wherein
the stripe pattern that the background forming section causes the reading section to read includes black and white.

12. The image reading device according to claim 2, wherein
the stripe pattern that the background forming section causes the reading section to read has a maximum density color of gray.

13. The image reading device according to claim 2, wherein
the stripe pattern read from the background forming section by the reading section is a horizontal stripe pattern in which stripes extend along a main scanning direction of the reading section.

14. The image reading device according to claim 2, wherein
the stripe pattern read from the background forming section by the reading section is an inclined stripe pattern intersecting with both a main scanning direction and a sub-scanning direction of the reading section.

15. The image reading device according to claim 3, wherein
when a reading resolution at which the reading section reads the document is a first resolution, the control section calculates a first judgment value based on brightness values of the M-number of pixels using a first calculation equation created on a premise that the stripe pattern in the image data is two-color stripes of two colors of light and dark, and
when the reading resolution is a second resolution that is lower than the first resolution, the control section calculates the second judgment value based on brightness values of the M−number of pixels using the second calculation equation created on the premise that the stripe pattern in the image data is multicolors of stripes of three or more colors including one or more colors of intermediate density between the two colors of light and dark.

16. The image reading device according to claim 3, wherein
the control section sets, as an edge of the document area, a pixel located outside or inside by a predetermined number of pixels with respect to the target pixel where the presence or absence of the short cycle fluctuation switches.

17. A document area discrimination method in an image reading device, the method comprising:
discriminating between a document area and a background area in image data read by a reading section configured to read an image of a document;
acquiring image data of the document having a pattern with a specific cycle as a background by causing the document to be read by the reading section; and
determining presence or absence of a short cycle fluctuation, which is a cyclical fluctuation in brightness value specific to the pattern, for each single unit and based on brightness value of M-number of pixels in each single unit, wherein
three or more M-number of pixels continuous in a direction with the cycle of the pattern in the image data are considered as a single unit; and
discriminating between the document area and the background area based on a position where the presence or absence of the short cycle fluctuation of a plurality of units obtained from image data switches.

18. A non-transitory computer-readable storage medium storing a program to be executed by a computer of an image reading device, the image reading device including a reading section configured to read an image of a document, the program causing the computer to determine a document area and a background area in image data read by the reading section, wherein
the program causing the computer to
cause the reading section to read the document and retrieve, from a memory section, image data of the document having a pattern with a specific cycle as a background,
perform a determination process of determining presence or absence of a short cycle fluctuation, which is a cyclical fluctuation in brightness value specific to the pattern, for each single unit and based on brightness value of M-number of pixels in each single unit,
three or more M-number of pixels continuous in a direction with the cycle of the pattern in the image data are considered as a single unit, and
perform a discrimination process of discriminating the document area and the background area based on a position where the presence or absence of the short cycle fluctuation of a plurality of units obtained from image data switches.
